(19) United States
(12) Patent Application Publication
(10) Pub. No.: US 2007/0153384 A1
(43) Pub. Date: Jul. 5, 2007

(54) Reinforced reflective polarizer films

(76) Inventors: Andrew J. Ouderkirk, Woodbury, MN (US); Olester Benson JR., Woodbury, MN (US); Timothy J. Hebrink, Scandia, MN (US); Shandon D. Hart, Maplewood, MN (US); Kristin L. Thunhorst, Stillwater, MN (US); Patrick R. Fleming, Lake Elmo, MN (US)

Correspondence Address: 3M INNOVATIVE PROPERTIES COMPANY, PO BOX 33427, ST. PAUL, MN, 55133-3427, US

(21) Appl. No.: 11/322,324

(22) Filed: Dec. 30, 2005

(51) Int. Cl. G02B 5/30

(52) U.S. Cl. 359/500; 359/495

(57) ABSTRACT

An optical film has a first layer and a second layer. The first and second layers each include fibers embedded within respective polymeric matrices. A third layer having a reflective polarizer layer is mounted between the first and second layers.

### FIELD OF THE INVENTION

The invention relates to optical films and more particularly to reflective polarizer films that are reinforced using inorganic fibers.

### BACKGROUND

Optical films, such as reflective polarizer films, are often used in displays, for example, for managing the propagation of light from a light source to a display panel. In particular, a reflective polarizer film is often used for transmitting, for the most part, one polarization of light that is incident on a liquid crystal display (LCD) panel, and for reflecting, for the most part, the light in the orthogonal polarization. The reflected light is recycled and returned to the reflective polarizer after at least some of the light has had its polarization altered to a state that is, for the most part, transmitted through the polarizer. This recycling process results in an increase in the amount of the polarized light that is incident on the LCD panel.

As display systems increase in size, the area of the films also becomes larger. Such polarizing films are thin, typically a tens or a few hundreds of microns and, therefore, present challenges in manual assembly and handling processes, especially when used in larger display systems. It is often impractical to simply change the thickness of the reflective polarizer without changing its optical or cosmetic characteristics. The reflective polarizer film can, however, be laminated to a relatively thicker polymer substrate to provide the support needed for a large area film. The use of a thick substrate, however, increases the thickness of the display unit, and also leads to increases in the weight and, possibly, in the optical absorption. The use of a thicker polymer substrate also increases thermal insulation, reducing the ability to transfer heat out of the display. Furthermore, there are continuing demands for displays with increased brightness, which sometimes means that more heat is generated with the display systems. This leads to an increase in the distorting effects that are associated with higher heating, for example film warping. An added thick polymer substrate does not necessarily reduce the coefficient of thermal expansion (CTE) of the film, which is helpful in reducing warp. Moreover, the lamination of the film to the thick polymer substrate makes the device thicker and heavier, without providing any improvement in the optical function of the display.

### SUMMARY OF THE INVENTION

One embodiment of the invention is directed to an optical film that has a first layer and a second layer. The first and second layers each include fibers embedded within respective polymeric matrices. A third layer having a reflective polarizer layer is mounted between the first and second layers.

Another embodiment of the invention is directed to a method of manufacturing an optical film that includes providing a reflective polarizer layer; and attaching a first fiber reinforced layer to a first side of the reflective polarizer layer. The first fiber layer comprises inorganic fibers disposed within a first polymer matrix.

The above summary of the present invention is not intended to describe each illustrated embodiment or every implementation of the present invention. The following figures and the detailed description more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a display system that uses a reflective polarizer according to principles of the present invention;

FIG. 2A schematically illustrates an exemplary embodiment of a fiber reinforced polarizer film having a reinforced layer attached directly to a polarizer layer, according to principles of the present invention;

FIG. 2B schematically illustrates an exemplary embodiment of a fiber reinforced polarizer film having a reinforced layer attached to a polarizer layer via an adhesive layer, according to principles of the present invention;

FIGS. 3A and 3B schematically illustrate embodiments of systems for manufacturing a fiber reinforced polarizer film, according to principles of the present invention;

FIG. 4 schematically illustrates another embodiment of a system for manufacturing a fiber reinforced polarizer film, according to principles of the present invention;

FIG. 5 schematically illustrates an embodiment of a reinforced polarizer film having two reinforcing layers, according to principles of the present invention;

FIG. 6 schematically illustrates an embodiment of a reinforced polarizer film having another attached optical film, according to principles of the present invention;

FIGS. 7A-7D schematically illustrate embodiments of reinforced polarizer films with attached optical layers having prismatic surfaces, according to principles of the present invention;

FIGS. 8A and 8B schematically illustrate embodiments of reinforced polarizer films with attached optical layers having surfaces that provide optical power, according to principles of the present invention;

FIG. 8C schematically illustrates an embodiment of a reinforced polarizer film with an attached optical layer having a surface formed as a diffractive optical element, according to principles of the present invention;

FIG. 9 schematically illustrates an embodiment of a reinforced polarizer film with an attached diffuser layer, according to principles of the present invention; and

FIG. 10 schematically illustrates an embodiment of a reinforced polarizer film with an attached light concentrator layer, according to principles of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is particularly applicable to optical display systems that use one or more optical films. As optical displays, for example liquid crystal displays (LCDs) become larger and brighter, the demands on optical films within the displays become greater. Larger displays require stiffer films, to prevent warping, bending and sagging, and to facilitate the assembly and manufacturing process of the backlight system. Scaling a film's thickness up with its length and width, however, leads to a thicker and heavier film. It is desirable, therefore, that optical films be made stiffer so that they can be used in large displays, without a concomitant increase in thickness. One approach for increasing the stiffness of the optical film is to include fibers within the film. In some exemplary embodiments, the fibers are matched in refractive index to the surrounding material of the film so that there is little, or no, scatter of the light passing through the film.

Some exemplary embodiments of reflective polarizer films include a reflective polarizer layer attached to a fiber-reinforced layer. The combination of the reflective polarizer, along with the beneficial properties of the fiber-reinforced layer, provide improved properties to the film assembly. It is preferable that the reinforcing fibers have a higher tensile modulus than the surrounding polymer matrix. Inorganic fiber, such as glass fibers, provide a fundamentally enhanced material property set that is generally inaccessible in homogenous polymer films. If properly arranged, the inorganic fibers can impart high stiffness to the composite article. In some cases, the fiber-reinforced layers can have a reduced coefficient of thermal expansion (CTE) in comparison to the reflective polarizer. When the fiber-reinforced layers are combined with the reflective polarizer, the overall CTE of the system is reduced from that which would occur with the polarizer alone. The reduction of the CTE is beneficial in reducing undesirable thermal effects such as differential shrinkage or expansion that can occur during thermal cycling of the display device. As a result of both increased stiffness and CTE reduction, the combination of the fiber-reinforced layers with the reflective polarizer permits the reflective polarizer to be made larger in area while maintaining a rigid form that may show reduced warp and deflection when operated in larger display systems. In addition, if the current warp performance of a certain product is already acceptable, then this same warp performance can be matched while reducing the thickness of the assembly. This reduced assembly thickness can be desirable in both large and small display systems.

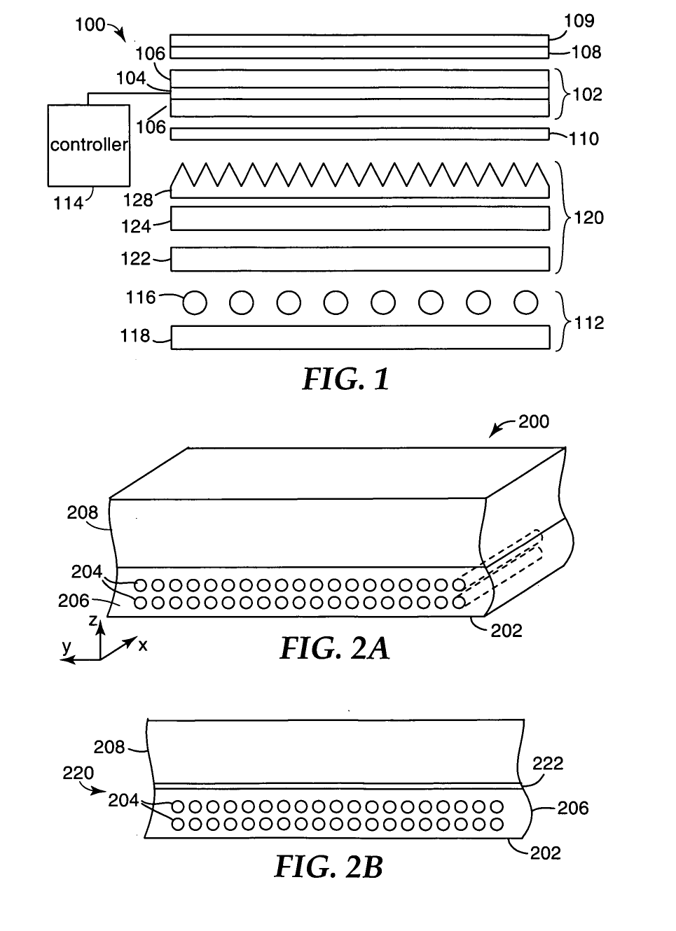

A schematic exploded view of an exemplary embodiment of a display system 100 that may include the invention is presented in FIG. 1. Such a display system 100 may be used, for example, in a liquid crystal display (LCD) monitor or LCD-TV. The display system 100 is based on the use of an LC panel 102, which typically comprises a layer of liquid crystal (LC) 104 disposed between panel plates 106. The plates 106 are often formed of glass, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent areas. A color filter may also be included with one or more of the plates 106 for imposing color on the image displayed.

An upper absorbing polarizer 108 is positioned above the LC layer 104 and a lower absorbing polarizer 110 is positioned below the LC layer 104. In the illustrated embodiment, the upper and lower absorbing polarizers are located outside the LC panel 102. The absorbing polarizers 108, 110 and the LC panel 102 in combination control the transmission of light from the backlight 112 through the display 100 to the viewer. In cases where a reflective polarizer is employed that has a sufficiently high extinction ratio, it may be possible to remove one or more absorbing polarizers from the system, for example replacing the absorbing polarizer with a reflecting polarizer.

The backlight 112 includes one or more light sources 116 that generate the light that illuminates the LC panel 102. The light sources 116 used in a LCD-TV or LCD monitor are often linear, cold cathode, fluorescent tubes that extend across the display device 100. Other types of light sources may be used, however, such as filament or arc lamps, light emitting diodes (LEDs), flat fluorescent panels or external fluorescent lamps. This list of light sources is not intended to be limiting or exhaustive, but only exemplary.

The backlight 1 12 may also include a reflector 1 18 for reflecting light propagating downwards from the light sources 116, in a direction away from the LC panel 102. The reflector 118 may also be useful for recycling light within the display device 100, as is explained below. The reflector 118 may be a specular reflector or may be a diffuse reflector. One example of a specular reflector that may be used as the reflector 118 is Vikuiti™ Enhanced Specular Reflection (ESR) film available from 3M Company, St. Paul, Minn. Examples of suitable diffuse reflectors include polymers, such as polyethylene terephthalate (PET), polycarbonate (PC), polypropylene, polystyrene and the like, loaded with diffusely reflective particles, such as titanium dioxide, barium sulphate, calcium carbonate and the like. Other examples of diffuse reflectors, including microporous materials and fibril-containing materials, are discussed in co-owned U.S. Patent Application Publication 2003/0118805 A1, incorporated herein by reference.

An arrangement 120 of light management layers is positioned between the backlight 112 and the LC panel 102. The light management layers affect the light propagating from backlight 112 so as to improve the operation of the display device 100. For example, the arrangement 120 of light management layers may include a diffuser layer 122. The diffuser layer 122 is used to diffuse the light received from the light sources, which results in an increase in the uniformity of the illumination light incident on the LC panel 102. Consequently, this results in an image perceived by the viewer that is more uniformly bright.

The arrangement 120 of light management layers may also include a reflective polarizer 124. The light sources 116 typically produce unpolarized light but the lower absorbing polarizer 110 only transmits a single polarization state, and so about half of the light generated by the light sources 116 is not transmitted through to the LC layer 104. The reflecting polarizer 124, however, may be used to reflect most of the light that would otherwise be absorbed in the lower absorbing polarizer, and so this light may be recycled by reflection between the reflecting polarizer 124 and the reflector 118. At least some of the light reflected by the reflecting polarizer 124 may be depolarized, and subsequently returned to the reflecting polarizer 124 in a polarization state that is transmitted through the reflecting polarizer 124 and the lower absorbing polarizer 110 to the LC layer 104. In this manner, the reflecting polarizer 124 may be used to increase the fraction of light emitted by the light sources 116 that reaches the LC layer 104, and so the image produced by the display device 100 is brighter.

Any suitable type of reflective polarizer may be used, for example, multilayer optical film (MOF) reflective polarizers; diffusely reflective polarizing film (DRPF), such as continuous/disperse phase polarizers or cholesteric reflective polarizers. Of these, some of the most optically efficient are reflective polarizers that rely on interference-based reflection. These interference-based reflective polarizers provide a periodically or quasi-periodically varying refractive index function (which may be referred to as optical repeat units) to a first polarization state, while a second (typically orthogonal) polarization state encounters a relatively uniform refractive index. This results in substantial reflection of the first polarization state and transmission of the second. Both quarter-wave MOF and cholesteric liquid crystal polarizers fall into this category. These both typically comprise polymeric materials that exhibit birefringence. These may employ polymers such as polyesters, PET, PEN, liquid crystal polymers, cholesteric liquid crystal polymers, and the like.

Both the MOF and continuous/disperse phase reflective polarizers rely on the difference in refractive index between at least two materials, usually polymeric materials, to selectively reflect light of one polarization state while transmitting light in an orthogonal polarization state. These typically include at least one birefringent material, and may include one positively and one negatively birefringent material. A first polarization state encounters a varying (not necessarily periodic) refractive index function while a second polarization state encounters a relatively uniform refractive index. This results in substantial scattering and reflection of the first polarization state and transmission of the second polarization state. These may employ polymers such as polyesters, PET, PEN, liquid crystal polymers, cholesteric liquid crystal polymers, and the like.

Some examples of MOF reflective polarizers, some models of which are referred to as DBEF, are described in co-owned U.S. Pat. No. 5,882,774, incorporated herein by reference. Commercially available examples of MOF reflective polarizers include Vikuiti™ DBEF-D200 and DBEF-D400 multilayer reflective polarizers that include diffusive surfaces, available from 3M Company, St. Paul, Minn.

Examples of DRPF useful in connection with the present invention include continuous/disperse phase reflective polarizers as described in co-owned U.S. Pat. No. 5,825,543, incorporated herein by reference, and diffusely reflecting multilayer polarizers as described in e.g. co-owned U.S. Pat. No. 5,867,316, also incorporated herein by reference. Other suitable types of DRPF are described in U.S. Pat. No. 5,751,388.

Some examples of cholesteric polarizer useful in connection with the present invention include those described in, for example, U.S. Pat. No. 5,793,456, and U.S. Patent Publication No. 2002/0159019. Cholesteric polarizers are often provided along with a quarter-wave retarding layer on the output side, so that the light transmitted through the cholesteric polarizer is converted to linear polarization.

The composites described herein can also be combined with absorbing polarizers and reflective polarizers together in one article serving multiple functions.

The arrangement 120 of light management layers may also include a prismatic brightness enhancing layer 128. A brightness enhancing layer is one that includes a surface structure that redirects off-axis light in a direction closer to the axis of the display. This increases the amount of light propagating on-axis through the LC layer 104, thus increasing the brightness of the image seen by the viewer. One example is a prismatic brightness enhancing layer, which has a number of prismatic ridges that redirect the illumination light, through refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT. These may also include prismatic ‘turning films’, where the prismatic surface is directed towards the light source or light guide.

Other light management layers may be included for purposes other than brightness enhancement. These uses include spatial mixing or color mixing of light, light source hiding, and uniformity improvement. Films that may be used for these purposes include diffusing films, diffusing plates, partially reflective layers, color-mixing lightguides or films, and non-Gaussian diffusers (diffusing systems in which the peak brightness ray of the diffused light propagates in a direction that is not parallel to the direction of the peak brightness ray of the input light). An example of a structured diffuser is a film having small canoe-shaped microstructures on its surface, as described in pending provisional U.S. Patent Application 60/729,370.

An exemplary embodiment of a reinforced polarizing film 200 is schematically illustrated in FIG. 2A. The reinforced film 200 includes a reinforcing layer 202 attached to a polarizing layer 208. The polarizing layer 208 may include any of the polarizing layers discussed above with regard to the reflective polarizer 124. The reinforcing layer 202 comprises a composite arrangement of inorganic fibers 204 disposed within a polymeric matrix 206.

The inorganic fibers 204 may be formed of glass, ceramic or glass-ceramic materials, and may be arranged within the matrix 206 as individual fibers, in one or more tows or in one or more woven layers. The fibers 204 may be arranged in a regular pattern or an irregular pattern. The fibers 204 may be milled or chopped. Several different embodiments of reinforced polymeric layers are discussed in greater detail in U.S. patent application Ser. No. 11/125,580 incorporated herein by reference.

The refractive indices of the matrix 206 and the fibers 204 may be chosen to match or not match. In some exemplary embodiments, it may be desirable to match the refractive indices so that the resulting article is nearly, or completely, transparent to the light from the light source. In other exemplary embodiments, it may be desirable to have an intentional mismatch in the refractive indices to create either specific color scattering effects or to create diffuse transmission or reflection of the light incident on the film. Refractive index matching can be achieved by selecting an appropriate fiber 204 reinforcement that has an index close to the same as that of the resin matrix 206, or by creating a resin matrix that has a refractive index close to, or the same as, that of the fibers 204.

The refractive indices in the x-, y-, and z-directions for the material forming the polymer matrix 206 are referred to herein as n₁ₓ, n_{1y} and n_{1z}. Where the polymer matrix material 206 is isotropic, the x-, y-, and z-refractive indices are all substantially matched. Where the matrix material is birefringent, at least one of the x-, y- and z-refractive indices is different from the others. When the fiber material is isotropic, the refractive index of the material forming the fibers is given as n₂. The reinforcing fibers 204 may, however, be birefringent.

In some embodiments, it may be desired that the polymer matrix 206 be isotropic, i.e. n₁ₓ≈n_{1y}≈n_{1z}≈n₁. Two refractive indices are considered to be substantially matched if the difference between the two indices is less than 0.05, preferably less than 0.02 and more preferably less than 0.01. Thus, the material is considered to be isotropic if no pair of refractive indices differs by more than 0.05. Furthermore, in some embodiments it is desirable that the refractive indices of the matrix 206 and the fibers 204 be substantially matched. Thus, the refractive index difference between the matrix 206 and the fibers 204, the difference between n₁ and n₂ should be small, at least less than 0.02, preferably less than 0.01 and more preferably less than 0.002.

In other embodiments, it may be desired that the polymer matrix be birefringent, in which case at least one of the matrix refractive indices is different from the refractive index of the fibers 204. In embodiments where the fibers 204 are isotropic, a birefringent matrix results in light in at least one polarization state being scattered by the reinforcing layer. The amount of scattering depends on several factors, including the magnitude of the refractive index difference for the polarization state being scattered, the size of the fibers 204 and the density of the fibers 204 within the matrix 206. Furthermore, the light may be forward scattered (diffuse transmission), backscattered (diffuse reflection), or a combination of both. Polarization-selective scattering or reflection can also be provided by birefringent fibers embedded in an isotropic matrix. Scattering of light by a fiber-reinforced layer 202 is discussed in greater detail in U.S. patent application Ser. No. 11/125,580.

Suitable materials for use in the polymer matrix 206 include thermoplastic and thermosetting polymers that are transparent over the desired range of light wavelengths. In some embodiments, it may be particularly useful that the polymers be non-soluble in water, the polymers may be hydrophobic or may have a low tendency for water absorption. Further, suitable polymer materials may be amorphous or semi-crystalline, and may include homopolymer, copolymer or blends thereof. Example polymer materials include, but are not limited to, poly(carbonate) (PC); syndiotactic and isotactic poly(styrene) (PS); C1-C8 alkyl styrenes; alkyl, aromatic, and aliphatic ring-containing (meth)acrylates, including poly(methylmethacrylate) (PMMA) and PMMA copolymers; styrene-acrylate copolymers, ethoxylated and propoxylated (meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; saturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/cyclo-aliphatic copolyester blends and polycarbonate/PET blends. The term (meth)acrylate is defined as being either the corresponding methacrylate or acrylate compounds. With the exception of syndiotactic PS, these polymers may be used in an optically isotropic form.

The most preferable polymer matrix material may very depending on processing conditions and other factors. For example, in some cases it may be desired to form the fiber-reinforced layer by UV or thermal curing of a monomer or monomer blend. In other cases it may be desired to form the reinforced composite layer from a molten thermoplastic polymer or polymer blend which solidifies upon cooling. Examples of both are discussed below. Various advantages will be described here, some of which apply equally to all processes and article constructions, and some of which only apply to certain specific processes or article constructions. These distinctions should be recognized by those skilled in the art.

In some product applications, it is important that film products and components exhibit low levels of fugitive species (low molecular weight, unreacted, or unconverted molecules, dissolved water molecules, or reaction byproducts). Fugitive species can be absorbed from the end-use environment of the product or film, e.g. water molecules, can be present in the product or film from the initial product manufacturing, e.g. water, or can be produced as a result of a chemical reaction (for example a condensation polymerization reaction). An example of small molecule evolution from a condensation polymerization reaction is the liberation of water during the formation of polyamides from the reaction of diamines and diacids. Fugitive species can also include low molecular weight organic materials such as monomers, plasticizers, etc.

The fugitive species are generally lower molecular weight than the majority of the material comprising the rest of the functional product or film. Product use conditions might, for example, result in thermal stress that is differentially greater on one side of the product or film. In these cases, the fugitive species can migrate through the film or volatilize from one surface of the film or product causing concentration gradients, gross mechanical deformation, surface alteration and, sometimes, undesirable out-gassing. The out-gassing could lead to voids or bubbles in the product, film or matrix, or problems with adhesion to other films. Fugitive species can, potentially, also solvate, etch or undesirably affect other components in product applications.

Several of these polymers may become birefringent when oriented. In particular, PET, PEN, and copolymers thereof, and liquid crystal polymers, manifest relatively large values of birefringence when oriented. Polymers may be oriented using different methods, including extrusion and stretching. Stretching is a particularly useful method for orienting a polymer, because it permits a high degree of orientation and may be controlled by a number of easily controllable external parameters, such as temperature and stretch ratio.

When an extrusion process is used to prepare the polymer matrix of the reinforced layer, the polymer composition of the composite layer is advantageously selected such that it can be extruded, remains transparent after processing at high temperatures, and is substantially stable at temperatures from at least about −30° C. to 85° C. The composite layer can be flexible and, in some embodiments, does not significantly expand in length or width over the temperature range of −30° C. to 85° C.

The composite layer typically includes, as a primary component, a polymeric material exhibiting a glass transition temperature (Tg) from 85° C. to 200° C., more typically from 100 to 160° C. The thickness of the composite layer can vary depending upon the application. However, the composite layer typically has a thickness in the range from 0.1 to 15 mils (approximately 2 μm to 375 μm), more typically from 0.5 to 10 mils (approximately 12 μm to 250 μm) thick, and even more typically from 1 to 7 mils (approximately 25 μm to 180 μm) thick. In some cases, thicker optical articles may be desired (such as 1-2 mm thick diffuser plates used in LCD-TV's); for the purposes of this application, the term ‘optical film’ should be considered to include these thicker optical plates or lightguides.

The composite layer may also include other materials blended with the polymer glass fiber composites described above. For example, coPEN or coPET can be used in the composite layer. CoPEN or coPET can, at least in some embodiments, phase separate within the mixture to form domains within the styrene-based polymer/copolymer or copolymer/copolymer combinations described above. Depending on the refractive index difference between the COPEN or COPET and the polymer matrix, the domains may cause diffusion of the light that passes through the matrix. In addition, in at least some embodiments, the addition of coPEN or coPET can aid in the adhesion of the composite layer to a reflective polarizer, or other optical film, containing coPEN or coPET. Optionally, coPEN and coPET can be used as an intermediate layer, between the composite layer and the layer to which the composite layer is being attached, to increase diffusion as well as to help retain the layers together.

Typically, COPEN or COPET may be used in the composite layer at levels of approximately 1 to 30 % weight of the material of the composite layer, more typically at 3 to 20 % weight and, in some embodiments, at 3 to 10 % weight. Surprisingly, it has been found that blending of materials, such as coPEN or coPET, with lower Tg and lower modulus than polystyrene or polystyrene copolymer into the composite improves the film's resistance to permanent warping. For example, blending CoPENs of lower modulus and lower Tg into composite layers comprising SAN results in a substantial reduction in the amount of warp measured in these films.

The COPEN and COPET copolymers may optionally include comonomers useful for increasing the glass transition temperature such as norbornene or tertiary butyl isophthalic acid. Other high Tg materials useful for blending into the composite layer include polycarbonate and polyetherimides such as Ultem™ obtainable from General Electric Plastics, Pittsfiled, Mass. These high T_{g} materials can be used at the same levels as coPEN and coPET.

The composite layer can be coated with one or more additional coatings to provide additional properties. Examples of such coatings include anti-static coatings, flame retardants, UV stabilizers, abrasion resistant or hardcoat materials, optical coatings, and anti-fogging coatings.

The matrix 206 may be provided with various additives to provide desired properties to the film 200. For example, the additives may include one or more of the following: an anti-weathering agent, UV absorbers, a hindered amine light stabilizer, an antioxidant, a dispersant, a lubricant, an anti-static agent, a pigment or dye, a nucleating agent, a flame retardant, a blowing agent or nanoparticles. In some exemplary embodiments, the matrix may include functionalized nanoparticles as a filler. Such nanoparticles are able to co-polymerize with the matrix and improve some mechanical properties such as modulus, scratch resistance and coefficient of thermal expansion (CTE). Such nanoparticles might also provide a way for manipulating the refractive index of the polymeric component of the reinforced layer.

In some cases, nanoparticles may be incorporated to improve properties such as stiffness, scratch resistance or refractive index modification. Nanoparticles are commercially available from companies such as ONDEO Nalco, which sells many different sizes of silica nanoparticles, such as Nalco 2327. Reaction of nanoparticles with silanes, such as methacryloxypropyltrimethoxy silane, provides reactive nanoparticles that will copolymerize into an acrylate matrix.

In some cases, it may be advantageous to apply one or more surface enhancement layers on the reinforcing layer. These additional layers can serve a variety of functions including surface protection and enhanced durability (in the example of a hardcoat), or easy-to-clean (in the example of a low surface energy coating). Examples of hardcoats that may be employed include ceramers, such as those described in U.S. Pat. No. 5,104,929. Such a hardcoat may be applied to provide durability and abrasion resistance.

In other embodiments, additional layers may be provided on one or both of the external surfaces of the film. For example, one or both of the layers may be provided with a layers that provides durability, for example abrasion resistant or hardcoat layers, or a layer that provides easy cleaning of the film. Examples of suitable hardcoats that may be employed include ceramers, such as those described in U.S. Pat. No. 5,104,929. Such a hardcoat may be applied to provide durability and abrasion resistance.

To provide easy clean character (sometimes referred to as antisoiling character), specific additives may be applied as a separate surface layer on top of a hardcoat layer, or in special cases may be added into the hardcoat layer. Generally the additives bloom to the surface so that low levels of the additive may provide the performance. Easy to clean additives include silicones and fluorinated molecules, although the latter are preferred due to their oil and dirt repellency. Of the fluorinated chemistries, those that are reactive (such as acrylates, silanes, vinyl ethers, and epoxides) are desirable owing to their ability to be copolymerized and therefore permanence. Perfluorinated acrylates, fluorinated acrylates, perfluoropolyether acrylates, fluorinated and perfluorinated multiacrylates (with more than one acrylate) are all useful in the development of an easy to clean film. Combinations of reactive fluorinated species with multifunctional crosslinkers, such as multifunctional acrylates (e.g. TMPTA, trimethylol propane triacrylate), ceramers, or mixtures with nanoparticles are especially desirable. An exemplary monofunctional perfluoropolyether acrylate compound is HFPO—C(O)N(H)CH₂CH₂OC(O)CH=CH₂, where HFPO refers to a preferred F(CF(CF₃)CF₂O)aCF(CF₃)— group wherein a averages 4 to 15. Multi acrylate versions of the HFPO are also useful.

Some suitable easy-clean chemistries include those which exhibit a contact angle greater than 90° (water) or greater than 500 (hexadecane) for the cured composition. An alternate method of assessing “easy-clean” performance is with a felt-tip type pen. The ink from the felt-tip type pen tends to “bead up” more as the surface becomes higher in surface energy, making it easier to wipe the ink away.

Easy-to-clean surfaces are not limited to one particular chemistry, but rather a large variety of chemicals could be used for this purpose as long as the desired level of optical transmission through the entire film construction is maintained. These additional surface enhancement layers can be coated or adhered onto the reinforcing layer sequentially so that the multiple surface enhancement layers are distinct from each other, or they might be integrated into one layer. Furthermore, in specially designed systems, the surface enhancing features might be made as a part of the reinforcing layer itself without the need for additional process steps.

The application of hardcoats and separate easy-to-clean surface enhancements and hardcoats possessing the easy-to-clean chemistries are described in U.S. Patent Applications having Ser. Nos. 10/841,159, 11/026,700 and 11/087,413, and also in U.S. Pat. No. 6,660,388. Some suitable HFPO multiacrylates are described in U.S. Patent Applications having Ser. Nos. 11/009,181 and 11/121,743. All the references in this paragraph are incorporated herein by reference.

These examples of additional surface layers are not meant to be limiting, but rather merely illustrative. Other surface layers or additional surface layers can be envisioned for applications in displays. Additional layers may also include static-reducing layers, electrically conductive or shielding layers, gas or moisture barrier layers, flame retardants, UV stabilizers, anti-reflective or other optical coatings, and anti-fogging coatings. Various other additional coatings and layers that may be added are described in U.S. Patent No. 6,368,699, incorporated herein by reference.

One or more strippable skin layers can also be provided over the composite layer for protecting the underlying optical films during storage and shipping. The strippable skin layers are typically removed prior to use of the film package. The strippable skin layers can be disposed onto the composite layer by coating, extrusion, or other suitable methods or can be formed by coextrusion or other suitable methods with the composite layer. The strippable skin layer can be adhered to the films using an adhesive, although in some embodiments, no adhesive is necessary. The strippable skin layers can be formed using any protective polymer material than has sufficient adherence (with or without adhesive as desired) to the dimensionally stable layer so that the strippable skin layer will remain in place until the strippable skin layer is removed manually or mechanically. Suitable materials include, for example, low melting and low crystallinity polyolefins such as copolymers of syndiotactic polypropylene (for example, Finaplas 1571 from Total Petrochemcials, Houston, Tex.), copolymers of propylene and ethylene (for example, PP8650 from Arkema Inc., Philadelphia, Pa.), or ethylene octene copolymers (for example, Affinity PT 1451 from Dow (Midland, Michigan). Optionally, a mixture of polyolefin materials can be utilized for the strippable skin layer. Preferably, the strippable skin material has a melting point of 80° C. to 145° C. according to differential scanning calorimetry (DSC) measurement, more preferably a melting point of 90° C. to 135° C. The skin layer resin typically has a melt flow index of 7 to 18 g/l Ominutes, preferably 10 to 14 g/10 minutes as measured according to ASTM D1238-95 (“Flow Rates of Thermoplastics by Extrusion Plastometer”), incorporated herein by reference, at a temperature of 230° C. and a force of 21.6 N.

In some embodiments it is desired that there is no remaining material from the strippable skin layer or any associated adhesive, if used, after the strippable layer has been removed. The strippable skin layer typically has a thickness of at least 12 μm. Optionally, the strippable skin layer may include a dye, pigment, or other coloring material so that it is easier for the user to determine whether or not the strippable skin layer is on the film. In some embodiments, the strippable skin layer may also include particles disposed in the strippable skin layer that are sufficiently large (for example, at least 0.1 μm) for embossing the underlying composite layer by application of pressure to the film with the strippable skin layer. Other materials may be blended into the strippable skin layer to improve adhesion to the composite layer. Modified polyolefins containing vinyl acetate or maleic anhydride may be particularly useful for improving adhesion of the strippable skin layers to the composite layers.

In some embodiments, the strippable skin layers may include rough strippable skin layers, which impart a roughness to the exposed layer when stripped, as is discussed further in U.S. patent application Ser. No. 10/977,211, incorporated herein by reference.

Some exemplary embodiments may use a polymer matrix material that is resistant to yellowing and clouding with age. For example, some materials such as aromatic urethanes become unstable when exposed long-term to UV light, and change color over time. It may be desired to avoid such materials when it is important to maintain the same color for a long term.

Other additives may be provided to the matrix 206 for altering the refractive index of the polymer or increasing the strength of the material. Such additives may include, for example, organic additives such as polymeric beads or particles and polymeric nanoparticles. In some embodiments, the matrix is formed using a specific ratio of two or more different monomers, where each monomer is associated with a different final refractive index when polymerized. The ratios of the different monomers determine the refractive index of the final resin 206.

In other embodiments, inorganic additives may be added to the matrix 206 to adjust the refractive index of the matrix 206, or to increase the strength and/or stiffness of the material. For example, the inorganic material may be glass, ceramic, glass-ceramic or a metal-oxide. Any suitable type of glass, ceramic or glass-ceramic, discussed below with respect to the inorganic fibers, may be used. Suitable types of metal oxides include, for example, titania, alumina, tin oxides, antimony oxides, zirconia, silica, mixtures thereof or mixed oxides thereof. The metal oxide nanoparticles can be modified such that the surfaces have organic modifiers attached. These surface modifiers can include reactive species that will react with and become incorporated with the matrix resin during the curing process. Such inorganic materials may be provided as nanoparticles, for example milled, powdered, bead, flake or particulate in form, and distributed within the matrix. The metal oxide nanoparticles can be modified such that the surfaces have organic modifiers attached. These surface modifiers can include reactive species that will react with and become incorporated with the matrix resin during the curing process. The size of the particles is preferably lower than about 200 nm, and may be less then 100 nm or even 50 nm to reduce scattering of the light passing through the matrix 206. The use of additives is discussed in greater detail in U.S. patent application Ser. No. 11/125,580.

The film may optionally include one or more layers in addition to the reflecting polarizer layer and the composite layer or layers. Such additional layers typically function to improve the integrity of the composite optical body. In particular, the additional layers may serve to bind the reflective polarizer layer to the composite layer. In certain implementations the composite layer and the reflective polarizer layer will not form a strong bond directly to one another. In such implementations, an intermediate layer advantageously adheres the composite layer to the reflective polarizer layer.

The composition of the intermediate layers is typically chosen in order to be compatible with the composite layer and the reflective polarizer layer. The intermediate layers may bind well to both the optical film and the dimensionally stable layer. Therefore, the choice of the material used in the intermediate layer will often vary depending upon the composition of the composite layer and the reflective polarizer layer.

In certain implementations the intermediate layer may be an extrudable transparent hot melt adhesive. Such layers can include coPENs containing one or more of naphthalene dicarboxylic acid (NDC), dimethyl terepthalate (DMT), hexane diol (HD), trimethylol propane (TMP), and ethylene glycol (EG). Layers that contain NDC are particularly well suited to adhering the composite layer to reflective polarizer layers containing PEN or COPEN, or both. In such implementations, the CoPEN of the intermediate layer typically contains from 20 to 80 parts NDC, preferably 30 to 70 parts NDC, and more preferably 40 to 60 parts NDC, per 100 parts of the carboxylate component of the coPEN.

Various additional compounds may be added, including the comonomers previously listed. Extrusion aids such as plasticizers and lubricants may also be added for improved processing and adhesion to other layers. Also, particles such as inorganic spheres or polymer beads with a different refractive index from the adhesive polymer can be used.

Other materials useful for intermediate layers include polyolefins modified with vinyl acetate such as Elvax™ polymers from Dupont and polyolefins modified with maleic anhydride such as Bynel™ polymers from Dupont and Admerr polymers from Mitsui Chemicals, White Plains, N.Y.

In certain implementations, an intermediate layer is integrally formed with the reflective polarizer layer, the composite layer, or both. The intermediate layer may be integrally formed with the optical film by being a skin coat on the exposed surfaces of the reflective polarizer layer. The skin coat typically is formed by co-extrusion with the reflective polarizer layer to integrally form and bind the layers. Such skin coats are selected so as to improve the ability to bind subsequent layers to the reflective polarizer layer. Skin coats are particularly useful when the reflective polarizer layer would otherwise have a very low affinity to the specific composite layer that is being used. Similarly, an intermediate layer can be integrally formed with the composite layer by being simultaneously co-extruded or sequentially extruded onto the reflective polarizer layer. In yet other implementations of the invention, a skin layer may be formed on the reflective polarizer layer and another intermediate layer may be formed with the composite layer.

When an extrusion process is used, the intermediate layer or layers are preferably thermally stable in a melt phase at temperatures above 250° C. Thus, the intermediate layer does not substantially degrade during extrusion at temperatures greater than 250° C. The intermediate layer is normally transparent or substantially transparent so as to avoid reducing the optical properties of the film. The intermediate layer is typically less than 2 mils (50 tm) thick, more typically less than 1 mil (25 μm) thick, and even more typically less than about 0.5 mil (12 μm) thick. The thickness of the intermediate layer is preferably minimized in order to maintain a film package.

The intermediate layer can also be comprised of a primer, known to those skilled in the art, which promotes adhesion between the polarizer layer and reinforcing (or other) layer.

In addition to the intermediate adhesive layer and the fiber composite layer, a top skin coat layer may be coextruded, laminated or otherwise attached on top of the fiber composite layer to better cover or conceal the glass fibers. This top skin coat layer can be the same polymer as the polymer in the fiber composite layer, or it can be a different polymer. In some embodiments, it may be desired that the top skin coat layer have a similar refractive index to that of the underlying polymer matrix.

In another exemplary embodiment of a reinforced polarizer film 220, schematically illustrated in FIG. 2B, a layer of adhesive 222 is provided between the reflective polarizer layer 208 and the fiber reinforcement layer 202. The adhesive 222 may be any suitable type of adhesive such as a photopolymerizable laminating adhesive or a pressure sensitive adhesive. Many adhesive options are available and are well known to those who are skilled in the art. Some types of adhesives that are suitable for use as tie-layer for coextrusion coating of the fiber composite onto DBEF or APF include amorphous copolyesters, especially copolyesters containing NDC (naphthalate dicarboxylate). APF is a uniaxially stretched multilayer reflective polarizer, the manufacture of which is discussed in U.S. patent applications Ser. Nos. 10/933,729 and 10/933,895, incorporated herein by reference. APF is available from 3M Company, St. Paul, Minn.

In another exemplary embodiment of a reinforced polarizer film 220, schematically illustrated in FIG. 2B, a layer of adhesive 222 is provided between the reflective polarizer layer 208 and the fiber reinforcement layer 202.

Any suitable type of inorganic material may be used for the fibers 204. The fibers 204 may be formed of a glass that is substantially transparent to the light passing through the film. Examples of suitable glasses include glasses often used in fiberglass composites such as E, C, A, S, R, and D glasses. Higher quality glass fibers may also be used, including, for example, fibers of fused silica and BK7 glass. Suitable higher quality glasses are available from several suppliers, such as Schott North America Inc., Elmsford, N.Y. It may be desirable to use fibers made of these higher quality glasses because they are purer and so have a more uniform refractive index and have fewer inclusions, which leads to less scattering and increased transmission. Also, the mechanical properties of the fibers are more likely to be uniform. Higher quality glass fibers are less likely to absorb moisture, and thus the film becomes more stable for long term use. Furthermore, it may be desirable to use a low alkali glass, since alkali content in glass increases the absorption of water.

Another type of inorganic material that may be used for the fiber 204 is a glass-ceramic material. Glass-ceramic materials generally comprise 95% -98% vol. of very small crystals, with a size smaller than 1 micron. Some glass-ceramic materials have a crystal size as small as 50 nm, making them effectively transparent at visible wavelengths, since the crystal size is so much smaller than the wavelength of visible light that virtually no scattering takes place. These glass-ceramics can also have very little, or no, effective difference between the refractive index of the glassy and crystalline regions, making them visually transparent. In addition to the transparency, glass-ceramic materials can have a rupture strength exceeding that of glass, and are known to have coefficients of thermal expansion of zero or that are even negative in value. Glass-ceramics of interest have compositions including, but not limited to, Li₂O—Al₂O₃—SiO₂, CaO—Al₂O₃—SiO₂, Li₂O—MgO—ZnO—Al₂O₃—SiO₂, Al₂O₃—SiO₂, and ZnO—Al₂O₃—ZrO₂—SiO₂, Li₂O—Al₂O₃—SiO₂, and MgO—Al₂O₃—SiO₂.

Some ceramics also have crystal sizes that are sufficiently small that they can appear transparent if they are embedded in a matrix polymer with an index of refraction appropriately matched. The Nextel™ Ceramic fibers, available from 3M Company, St. Paul, Miin., are examples of this type of material, and are available as thread, yarn and woven mats. Suitable ceramic or glass-ceramic materials are described further in Chemistry of Glasses, 2^{nd} Edition (A. Paul, Chapman and Hall, 1990) and Introduction to Ceramics, 2^{nd} Edition (W. D. Kingery, John Wiley and Sons, 1976), the relevant portions of both of which are incorporated herein by reference.

In some exemplary embodiments, it may be desirable not to have perfect refractive index matching between the matrix 206 and the fibers 204, so that at least some of the light is diffused by the fibers 204. In such embodiments, either or both of the matrix 206 and fibers 204 may be birefringent, or both the matrix and the fibers may be isotropic. Depending on the size of the fibers 204, the diffusion arises from scattering or from simple refraction. Diffusion by a fiber is non-isotropic: light may be diffused in a direction lateral to the axis of the fiber, but is not diffused in an axial direction relative to the fiber. Accordingly, the nature of the diffusion is dependent on the orientation of the fibers within the matrix. If the fibers are arranged, for example, longitudinally parallel to the x-axis, then the light is generally diffused in directions parallel to the y-axis.

In addition, the matrix 206 may be loaded with diffusing particles that isotropically scatter the light. Diffusing particles are particles of a different refractive index than the matrix, often a higher refractive index, having a diameter up to about 10 μm. The diffusing particles may be, for example, metal oxides such as were described above for use as nanoparticles for tuning the refractive index of the matrix. Other suitable types of diffusing particles include polymeric particles, such as polystyrene or polysiloxane particles, or a combination thereof. The diffusing particles may be used alone to diffuse the light, or may be used along with non-index-matched fibers to diffuse the light.

Some exemplary arrangements of fibers 204 within the matrix 206 include yarns, tows of fibers or yarns arranged in one direction within the polymer matrix, a fiber weave, a non-woven, chopped fiber, milled fiber, a chopped fiber mat (with random or ordered formats), or combinations of these formats. The chopped fiber mat or nonwoven may be stretched, stressed, or oriented to provide some alignment of the fibers within the nonwoven or chopped fiber mat, rather than having a random arrangement of fibers. Furthermore, the matrix 206 may contain multiple layers of fibers 204: for example the matrix 206 may include more layers of fibers in different tows, weaves or the like. In the specific embodiment illustrated in FIG. 2A, the fibers 204 are arranged in two layers. In many cases, a continuous or woven fiber reinforcement may provide higher stiffness to the final article owing to the continuous fiber's higher load-bearing capability.

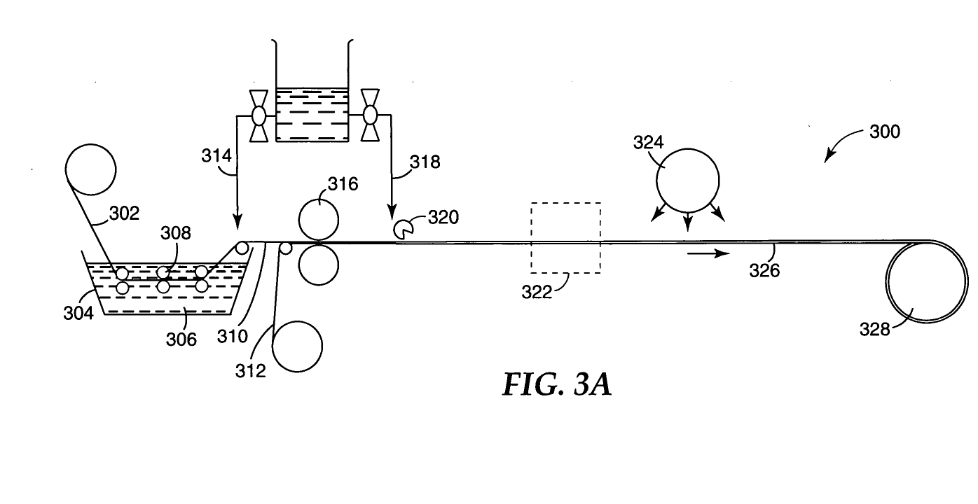

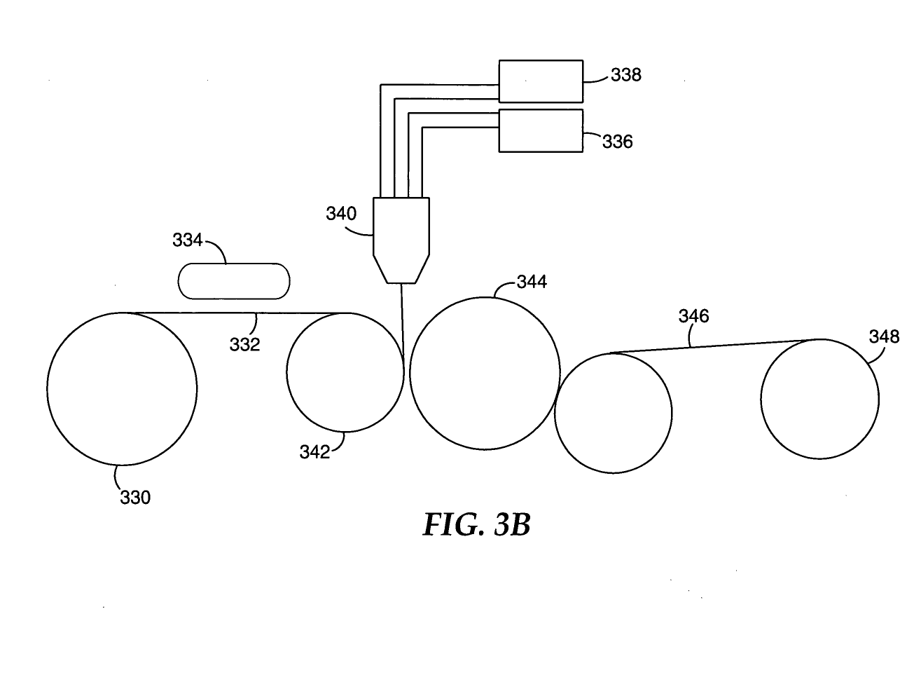

One exemplary approach to manufacturing a reinforced polarizer film is now described with reference to FIG. 3. In general, this approach includes applying a matrix resin directly to a pre-prepared reflecting polarizer layer. The manufacturing arrangement 300 includes a roll of the fiber reinforcement 302, which is passed through an impregnation bath 304 containing the matrix resin 306. The resin 306 is impregnated into the fiber reinforcement 302 using any suitable method, for example by passing the fiber reinforcement 302 through a series of rollers 308.

Once the impregnated reinforcement 310 is extracted from the bath 304, it is applied to a reflective polarizer layer 312 and additional resin 314 may be added if necessary. The impregnated fiber reinforcement 310 and the reflective polarizer layer 312 are squeezed together in a pinch roller 316 to ensure good physical contact between the two layers 310 and 312. Optionally, additional resin 318 may be applied over the reinforcement layer 310, for example using a coater 320. The coater 320 may be any suitable type of coater, for example a knife edge coater, comma coater (illustrated), bar coater, die coater, spray coater, curtain coater, high pressure injection, or the like. Among other considerations, the viscosity of the resin at the application conditions determines the appropriate coating method or methods. The coating method and resin viscosity also affect the rate and extent to which air bubbles are eliminated from the reinforcement during the step where the reinforcement is impregnated with the matrix resin.

Where it is desired that the finished film have low scatter, it is important at this stage to ensure that the resin completely fills the spaces between the fibers: voids or bubbles left in the resin may act as scattering centers. Different approaches may be used, individually or in combination, to reduce the occurrence of bubbles. For example, the film may be mechanically vibrated to encourage the dissemination of the resin 306 throughout the reinforcement layer 310. The mechanical vibration may be applied using, for example, an ultrasonic source. In addition, the film may be subject to a vacuum that extracts the bubbles from the resin 306. This may be performed at the same time as coating or afterwards, for example in an optional de-aeration unit 322.

The resin 306 in the film may then be solidified at a solidification station 324. Solidification includes curing, cooling, cross-linking and any other process that results in the polymer matrix reaching a solid state. In the illustrated embodiment, a radiation source 324 is used to apply radiation to the resin 306. In other embodiments different forms of energy may be applied to the resin 306 including, but not limited to, heat and pressure, UV radiation, actinic radiation, electron beam radiation and the like, in order to cure the resin 306. In other embodiments, the resin 306 may be solidified by cooling or by cross-linking. In some embodiments, the solidified film 326 is sufficiently supple as to be collected and stored on a take-up roll 328. In other embodiments, the solidified film 326 may be too rigid for rolling, in which case it is stored some other way, for example the film 326 may be cut into sheets for storage.

Additional or alternative methods may be used for forming the composite film package of the present invention. The film package can take on various configurations, and thus the methods vary depending upon the configuration of the final film package.

A step common to all methods of forming the composite film package is adhering the reflective polarizer to the composite layer or layers. This step can be conducted in a variety of ways in addition to the impregnation bath, coating methods, and adhesives described above, such as co-extruding various layers, extrusion coating the layers, or co-extrusion coating of the layers, for example when a composite layer and an intermediate layer are simultaneously extrusion coated onto the reflective polarizer.

FIG. 3B shows a plan view of a system for forming an optical film in accordance with one implementation of the invention. Spool 330 containing a reflective polarizer layer 332 is unwound and heated at infrared heating station 334. The reflective polarizer layer 332 is normally raised to a temperature above 50° C., and more commonly to a temperature of approximately 75° C. A first composition 336 for forming a composite layer and a second composition 338 for forming an intermediate adhesive layer are fed through feed block 340 and are coextrusion coated onto the preheated optical film 332. The first composition 336 contains polymer for forming the matrix, which is embedded with fibers, for example chopped fibers. Thereafter, the coated film is pressed between rolls 342 and 344. Roll 342, roll 344, or both, optionally contain a matte-finish to impart a slightly diffuse surface on the composite layer. After cooling, the reinforced polarizer film 346 can be subsequently processed, such as by cutting into sheets, to form a finished film package that is rolled onto winder 348.

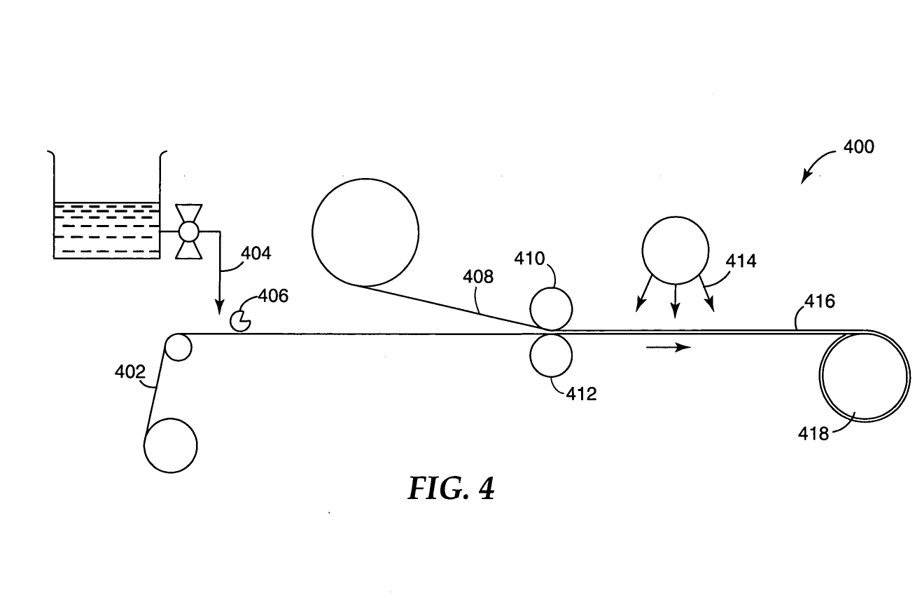

Another approach to making a fiber reinforced polarizer is to make the composite layer first on a carrier film from which it will later be separated. The composite layer can be subsequently fed into a lamination process with a laminating adhesive or pressure sensitive adhesive, and the desired optical film. This approach is schematically illustrated in FIG. 4. In this manufacturing system 400, a layer of adhesive 404 is provided on a reflective polarizing film 402. The adhesive 404 may be any suitable type of adhesive useful for laminating two films together. For example, the adhesive may be of the type discussed above. In the illustrated embodiment, the adhesive 404 is applied as a liquid which is spread to a thin layer using a coater 406.

A pre-prepared, fiber-reinforced, composite layer 408 is then laid over the adhesive 406 and the fiber-reinforced layer 408 is squeezed together with the reflective polarizing film 402, for example using a pressure roller 410, to form a reinforced laminate 412. If necessary, the adhesive 404 may then be cured, for example though the application of radiation 414. The cured laminate 416 may then be gathered on a roll 418 or cut into sheets for storage.

In a variation of this approach, the adhesive 404 may first be applied to the fiber-reinforced layer, and the reflective polarizer may then be pressed against the adhesive 404.

Photoinitiated grafting or graft copolymerization are methods of surface preparation/attachment that may be useful for the attachment of composite layers to reflective polarizers or other surfaces.

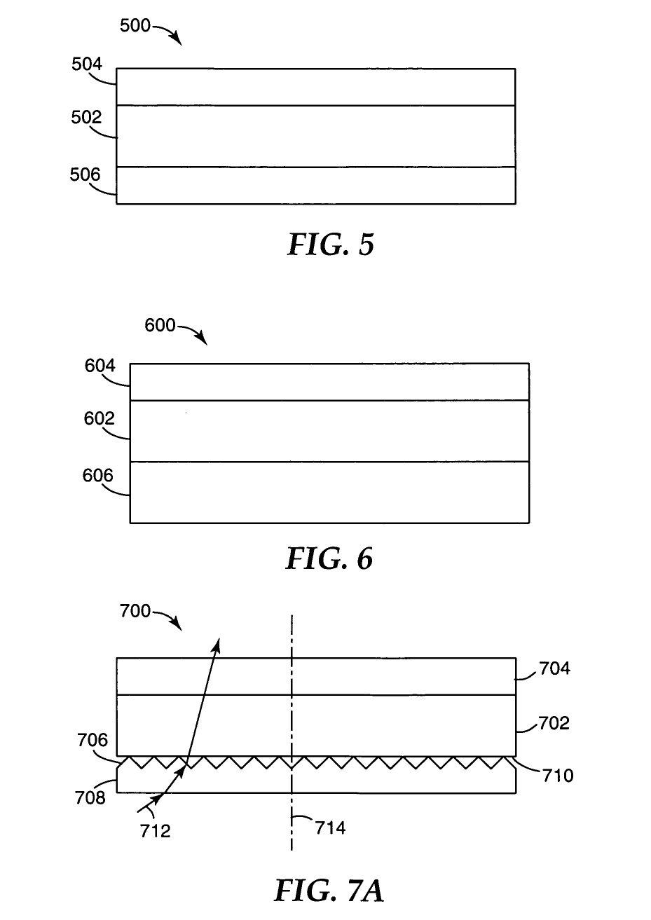

It will be appreciated that a fiber reinforced layer may be attached to each side of a reflective polarizer film. FIG. 5 schematically illustrates an exemplary embodiment of a reinforced reflective polarizer 500 that has a reflective polarizer layer 502 sandwiched between two fiber reinforcement layers 504, 506. The fiber reinforcement layers 504, 506 may be attached using an adhesive or may be attached by curing the matrix of the reinforcement layer 504, 506 to the reflective polarizer layer 502. In some cases, a primer might be required to ensure adequate adhesion between the matrix of the reinforcing layer and the polarizing film.

This arrangement, in which the reflective polarizer layer 502 is disposed between two fiber reinforcement layer 504, 506, may be used to reduce warping when used in applications where the temperature of the reflective polarizer undergoes significant changes. The coefficient of thermal expansion of the fiber-reinforced layers 504, 506 is typically less than that of the polymer reflective polarizer layer 502, due to the inorganic fibers. In cases where the film includes a reflective polarizer layer that is attached to only one fiber-reinforced layer, a significant temperature change may result in bending of the film due to the difference between the thermal expansion coefficients of the two layers. The use of a second fiber-reinforced layer makes the thermally-induced stresses in the film more symmetrical and, therefore, reduces temperature-dependent deformation. The thermal expansion coefficient of the two fiber-reinforced layers 504, 506 may be substantially the same, for example within 20% of each other.

Other layers may also be attached to the reinforced reflective polarizer, for example attached directly to the reflective polarizer layer or to a fiber reinforced layer that is attached to the reflective polarizer layer. The reinforced reflective polarizer may include one or more fiber-reinforced layers. A general example of a reinforced polarizer 600 layer that includes an additional optical layer is schematically illustrated in FIG. 6. In the illustrated embodiment, the reinforced polarizer 600 has a reflective polarizer layer 602 that is attached to a fiber-reinforced layer 604. An additional optical layer 606 is attached to the reflective polarizer layer 602. The optical layer 606 may be any other optical layer that is desired to be attached to the reinforced reflective polarizer 600. For example, the optical layer 606 may include an optical layer that is transmissive, diffusive or reflective. A diffusive layer may, for example, include optically diffusive particles dispersed within a matrix. A reflective layer may be a specularly reflective layer, for example a multi-layer film formed from polymer or other dielectric materials. In some exemplary embodiments, the optical layer 606 may be another polarizer layer, for example a reflective polarizer or an absorbing polarizer.

In other exemplary embodiments, the optical layer 606 may be an optical layer that includes an optically functional surface. Different exemplary types of optical layers with optically functional surfaces include films with prismatic surfaces, films with lensed surfaces, films with diffractive surfaces, diffusive surfaces, and films with optically concentrating surfaces.

Films with prismatic surfaces include prismatic brightness enhancing films, in which the light passes out of the film through the prismatic surface, turning films, in which the light enters the film through the prismatic surface, and retroreflecting films, in which light enters the film through the surface opposite the prismatic surface, and is retroreflected by the prisms.

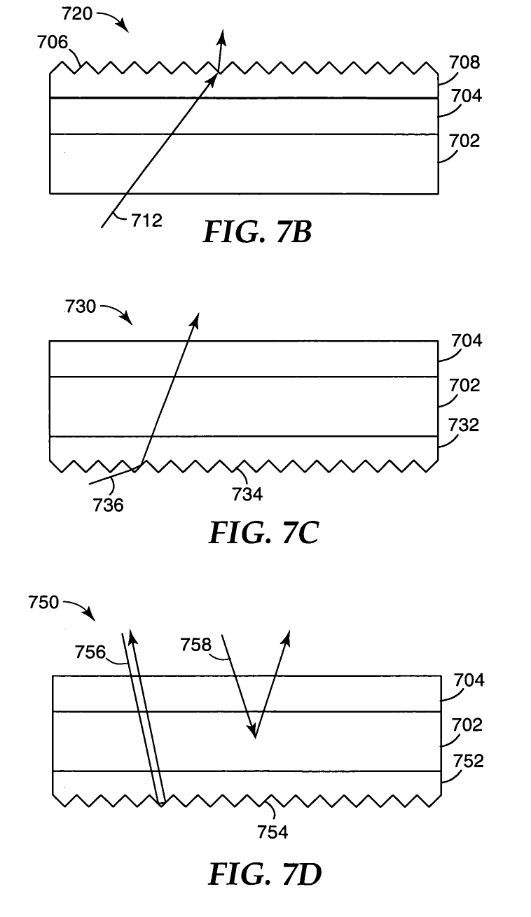

An exemplary embodiment of a reinforced polarizer film 700 that is attached to a prismatic film is schematically illustrated in FIG. 7A. The reinforced film 700 includes a reflective polarizer layer 702 attached to a fiber-reinforced layer 704. In this exemplary embodiment, the prismatic surface 706 of the prismatic brightness enhancing layer 708 is attached to the lower surface 710 of the reflective polarizer 702, for example through the use of a thin layer of adhesive on the surface 710. The attachment of prismatic brightness enhancing layers to other optical films is discussed in greater detail in U.S. Pat. No. 6,846,089, incorporated herein by reference. The figure also shows the optical path of one exemplary light ray 712 that is redirected by the prismatic brightness enhancing film in a direction more closely aligned with the axis 714.

In an alternative embodiment, schematically illustrated in FIG. 7B, the film 720 may be arranged so that the light 712 enters the reflective polarizer layer 702 before entering the brightness enhancing layer 708. In this embodiment, the fiber-reinforced layer 704 may be between the reflective polarizer layer 702 and the brightness enhancing layer 708, as illustrated, or the reflective polarizing layer 702 may be between the fiber-reinforced layer 704 and the brightness enhancing layer 708.

In some embodiments it may be desired to arrange the fibers in such a way, for example through controlling the fiber orientation angle, fiber thickness, or fiber pitch, to reduce or eliminate certain optical artifacts. One example of an optical artifact that could be removed is unwanted Moire patterns that could be formed between the fibers and other structures such as prism structures or pixel structures in parts of the display or backlight.

An exemplary embodiment of a reinforced polarizer film 730 that is attached to a turning film 732 is schematically illustrated in FIG. 7C. The reinforced film 730 includes a reflective polarizer layer 702 attached to a fiber-reinforced layer 704. The turning film 732 may be attached to the reflective polarizer layer 702 using any suitable method, such as using an adhesive layer (not shown) between the turning film 732 and the polarizer layer 702.

In this exemplary embodiment, the prismatic surface 734 of the turning film 732 is directed outwards towards the area from where the light 736 is directed to the reinforced film 730. At least some of the light 736 enters the prismatic surface 734 and is internally reflected, with the result that the light is directed up to the reflective polarizer layer 702. Where the light 736 is polarized in the pass polarization state of the polarizer layer 702, the light 736 is transmitted, as illustrated.

An exemplary embodiment of a reinforced polarizer film 750 that is attached to a retroreflecting film 752 is schematically illustrated in FIG. 7D. The reinforced film 750 includes a reflective polarizer layer 702 attached to a fiber-reinforced layer 704. The retroreflecting film 752 may be attached to the reflective polarizer layer 702 using any suitable method, such as using an adhesive layer (not shown) between the retroreflecting film 752 and the polarizer layer 702.

In this exemplary embodiment, the prismatic structure 754 of the retroreflecting film 752 is on the side of the reinforced film 750 directed away from the area from which the light is incident. At least some of the light 756 passes through the reflective polarizer 702 and is totally internally reflected by the structure so as to leave the retroreflecting film 752 in a direction substantially parallel to the incident direction. In such an arrangement, light polarized parallel to the transmission axis of the polarizing film 702 is retroreflected, while light 758 polarized parallel to the block axis of the polarizing film is specularly or diffusely reflected, depending the type of reflective polarizing film 702.

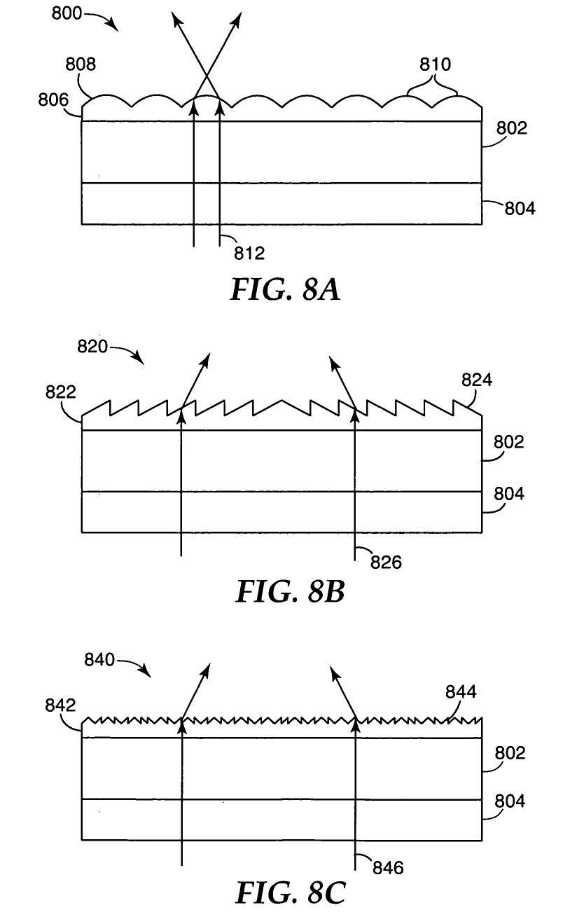

In another exemplary embodiment, an optical layer having a surface that is structured to provide optical power to the light passing therethrough may be attached to the reinforced polarizer. Examples of optical elements that provide optical power include conventional, curved refracting lenses; Fresnel lenses; and diffractive lenses. An exemplary embodiment of a reinforced polarizer film 800 that includes a layer that provides optical power is schematically illustrated in FIG. 8A. The reinforced film 800 includes a reflective polarizer layer 802 attached to a fiber-reinforced layer 804. The optical power film 806 may be attached to the reflective polarizer layer 802 using any suitable method, such as using an adhesive layer (not shown) between the optical power film 806 and the polarizer layer 802.

In this exemplary embodiment, the optical power film 806 includes a surface 808 that defines a number of refractive lenses 810. Light 812 passing through the lenses 810 is affected by the optical power of the lenses 810. In the illustrated embodiment, the lenses 810 are positive lenses, but one or more of the lenses may be negative lenses. In the illustrated embodiment the light 812 is polarized parallel to the pass axis of the polarizing film 802.

Another exemplary embodiment of a reinforced polarizer film 820 that includes a layer providing optical power is schematically illustrated in FIG. 8B. The reinforced film 820 includes a reflective polarizer layer 802 attached to a fiber-reinforced layer 804. The optical power film 822 may be attached to the reflective polarizer layer 802 using any suitable method, such as using an adhesive layer (not shown) between the optical power film 822 and the polarizer layer 802.

In this exemplary embodiment, the optical power film 822 includes a Fresnel lens surface 824. Light 826 passing through the Fresnel lens 824 is affected by the optical power of the optical power film 822. In the illustrated embodiment the light 826 focused by the Fresnel lens 824 is polarized parallel to the pass axis of the polarizing film 802.

The reinforced polarizer film may also be provided with a diffractive optical element layer, in other words a layer that defines a diffractive optical element (DOE). Diffractive optical elements may use surface diffraction, volume diffraction, or a combination of volume and surface diffraction. One exemplary embodiment of a surface DOE layer is schematically illustrated in FIG. 8C. The reinforced film 840 includes a reflective polarizer layer 802 attached to a fiber-reinforced layer 804. The DOE layer 842 has a diffracting surface 844 that diffracts the light 846 passing therethrough in a desired manner. In one exemplary embodiment, the DOE layer 842 provides optical power to the light 846, and functions as one or more lenses. The DOE layer 842 may be attached to the reflective polarizer layer 802 using any suitable method, such as using an adhesive layer (not shown) between the DOE film 842 and the polarizer layer 802.

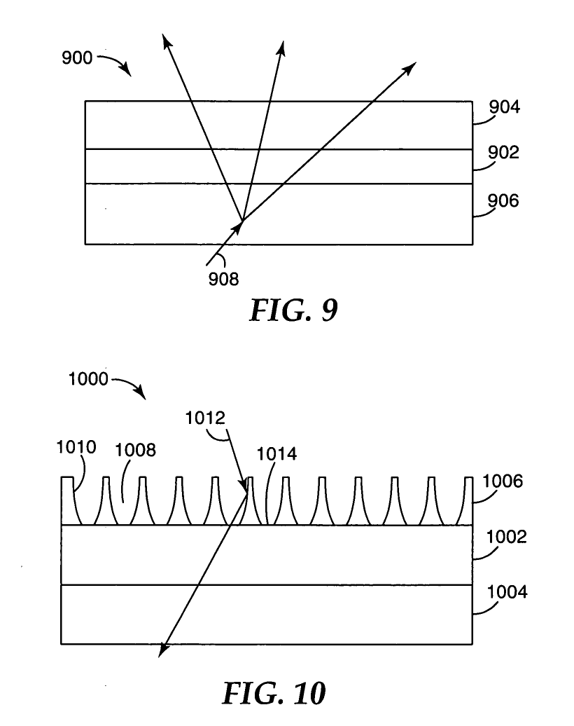

Another type of film that can be attached to a reinforced polarizer is a diffusing film. The diffusing film may be a bulk diffusing film or a surface diffusing film or a film that provides both bulk and surface diffusion. This diffusing film may be a so-called ‘gain diffuser’ that provides some amount of light collimation as well as diffusion to the incident light. An exemplary embodiment of a reinforced polarizer film 900 is schematically illustrated in FIG. 9. The reinforced polarizer film 900 has a polarizer layer 902 attached to one or more fiber reinforced layers 904. A diffuser layer 906 is attached to either the polarizer layer 902 or the reinforced layer 904. The diffuser layer 906 may be attached using any suitable method, for example through the use of an adhesive layer (not shown). In the exemplary embodiment, the light 908 is diffused by the diffuser layer 906 before being transmitted through the reflective polarizer layer 902. In some embodiments, the diffuser layer 906 may be a fiber-reinforced layer in which there is a refractive index mismatch between the reinforcing fibers and the polymer matrix.

Another type of film that can be attached to a reinforced polarizer is a light concentrator film. A light concentrator is a reflective element, typically a non-imaging element, that concentrates light from a large area to a smaller area. Examples of light concentrators include parabolic reflectors, compound parabolic reflectors and the like. In the illustrated exemplary embodiment, a reflective polarizer layer 1002 is attached to a fiber reinforced layer 1004 as discussed above. A concentrator film 1006 is attached to either the reflective polarizer layer 1002 or the fiber reinforced layer 1004. The concentrator film 1006 includes a number of reflective collectors 1008 that have reflecting sidewalls 1010. The light 1012 is concentrated at the output apertures 1014 of the collector film 1006. When illuminated in the opposite direction, the light concentrator can act as a light collimating film, which may be useful in display backlighting.

It will be appreciated that many of the different optical films that may be added to a reflective polarizer layer may both provide optical functionality and fiber reinforcement. For example, a layer having an optically functional surface, such as the prismatic films 708, 732 and 752 shown respectively in FIGS. 7A, 7B and 7C, or the lensed films 806, 822 or 842 shown respectively in FIGS. 8A, 8B and 8C, may be reinforced with inorganic fibers, as is described in greater detail in U.S. patent application Ser. No. 11/125,580. Furthermore, either the diffusing layer 906 or the light concentrating layer 1006 may be reinforced with inorganic fibers.

In the different embodiments of reinforced polarizer film illustrated in FIGS. 6-10, it is important to appreciate that the order and orientation of the different layers may be different from those illustrated. For example, in the embodiment of film 700 schematically illustrated in FIG. 7A, positions of the reflective polarizer layer 702 and the reinforced layer 704 may be switched, so that the prismatic brightness enhancing layer 708 is attached to the underside of the reinforced layer. Also, in all of the examples showing the addition of another optical film, there may be two or more fiber reinforced layers, instead of the single layer illustrated.

### EXAMPLES

Select embodiments of this invention are described below. These examples are not meant to be limiting, only illustrative of some of the aspects of the invention. Table I contains a summary of relevant information of the different inorganic fiber samples used in the different Examples.

TABLE I
Summary of various fiber materials used in the Examples

| Material | | Style | Yarn | Weight | Refractive |
|---|---|---|---|---|---|
| ID | Manufacturer | Number | Description | (g m⁻²) | Index |
| A | Hexcel | 106 | ECD 900 | 25 | 1.549 |
| | Reinforcements | | 1/0 | | |
| A* | Hexcel | 106 | ECD 900 | 25 | 1.551 |
| | Reinforcements | | 1/0 | | |
| B | Owens Corning | | | | 1.56 |

Fiber material A is a woven fiberglass in greige form (without a surface finish), while material A* is the same as material A, but with a CS-767 silane finish. Hexcel Reinforcements Corp. is located in Anderson, S.C. Fiber material B is a milled glass fiber made by Owens Corning, Toledo, Ohio, having a diameter of around 16 μm and lengths of around 5 mm. The Material A fibers were received from the vendor with sizing covering the fibers. Sizing is a layer on a fiber, often formed from starches, lubricants or a water-soluble polymer such as polyvinyl alcohol, that is used to facilitate processing or weaving of the fiber. In the examples described below that used the material A fibers, the sizing was left on the fibers before embedding the fibers in the polymer matrix. Consequently, the fibers were included in the composite samples without a coupling agent to couple between the fiber and the polymer matrix. The material A* fibers had the sizing removed by the manufacturer prior to addition of the CS-767 silane finish.

The refractive index (RI) of the fiber samples listed in Table I were measured with Transmitted Single Polarized Light (TSP) with a 20x/0.50 objective, and Transmitted Phase Contrast Zernike (PCZ) with a 20x/0.50 objective. The fiber samples were prepared for refractive index measurement by cutting portions of the fibers using a razor blade. The fibers were mounted in various RI oils on glass slides and covered with a glass coverslip. The samples were analyzed using the Zeiss Axioplan (Carl Zeiss, Germany). Calibration of the RI oils was performed on an ABBE-3L Refractometer, manufactured by Milton Roy Inc., Rochester, N.Y., and values were adjusted accordingly. The Becke Line Method accompanied with phase contrast was used to determine the RI of the samples. The nominal RI results for the values of nD, the refractive index at the wavelength of the sodium D-line, 589 nm, had an accuracy of ±0.002 for each sample.

Summary information for various thermosetting resins used in Examples 1-5 is provided in Table II.

TABLE II
Resin Components

| | | Resin | Refractive |
|---|---|---|---|
| Component ID | Manufacturer | Component | Index |
| C | Cytec Surface Specialties | Ebecryl 600 | 1.5553 |
| D | Sartomer Company, Inc. | CN 963 A 80 | 1.4818 |
| E | Sartomer Company, Inc. | SR 601 | 1.5340 |
| F | Sartomer Company, Inc. | SR 349 | 1.5425 |
| G | Ciba Specialty Chemicals | Darocur 1173 | 1.5286 |
| | Corp. | | |
| H | Sartomer Company, Inc. | SR 351 | 1.4723 |

All of the components in Table II, with the exception of Darocur 1173 (photoinitiator) are photopolymerizable resins that cross-link upon curing. CN963A80 is a urethane acrylate oligomer blended with tripropylene glycol diacrylate. Ebecryl 600 is a Bisphenol-A epoxy diacrylate oligomer. SR601 and SR349 are ethoxylated Bisphenol-A diacrylates. SR351 is trimethylolpropane triacrylate. The refractive index given for the components manufactured by Sartomer Company were taken from the product literature. The other component refractive indices were measured at 20° C. with an Abbe Refractometer. The values of the refractive index are given for the components in the liquid state. Cytec Surface Specialties is located in Brussels, Belgium, Sartomer Company, Inc. is located in Exton, Pa. and Ciba Specialty Chemicals Corp. is located in Tarrytown, N.J.

In some of the following examples it is stated that the reflective polarizer layer is directly attached to the composite layer. It should be understood that this means that there is no intervening layer placed between the reflective polarizer layer and composite layer, although a primer may optionally be used to aid the attachment of the two layers.

### Example 1

### DBEF Directly Attached to Composite Layer

In this example, a fiber reinforced layer was formed on a pre-existing layer of DBEF, a multilayer polymeric reflective polarizer manufactured by 3M Company. This polarizer is very similar to the commercially available polarizer sold by 3M Company as DBEF-P2, but has thinner skin layers. The fiber was fiber material A, listed in Table I. The resin mixture, Resin Mixture 1, was formed with the following weight % of the different resin components:

| Resin Component | Wgt % |
|---|---|
| C | 48.85 |
| D | 29.42 |
| E | 5.07 |
| F | 15.25 |
| G | 1.04 |

Resin Mixture 1 had a measured refractive index of 1.5470 or 1.5462, depending on the batch, after curing. In this example, four individual sheets of DBEF were primed and a layer of woven fiberglass and resin were applied to, degassed, and cured onto each side of each of the pieces of DBEF film. The primer was applied to improve the adhesion of the acrylate resin to the DBEF film. One primer is comprised of hexanediol diacrylate 97% (w/w) and benzophenone 3% (w/w). For priming 9″×12″ (22.9 cm×30.5 cm) sheets of film, three drops of the primer solution were applied to one surface of the film and coated using a paper tissue by wiping. The excess primer may be removed by wiping with a clean tissue. The primer coating was cured using a Fusion “H” lamp operating at 600 W/in (240 W/cm) at a line speed of 50 fpm (25 cm s⁻¹) in a nitrogen atmosphere. The primer coating was also curable in air at a slower line speed of ˜25 fpm (12.5 cm s⁻¹). The primed sheet of DBEF was subsequently used to prepare a reinforced DBEF composite.

The leading edge of a sheet of PET was taped to the leading edge of a sheet of aluminum. A primed sheet of DBEF was laid onto the PET. A sheet of glass fabric was laid on top the DBEF. The glass fabric was covered by a second sheet of PET. The leading edge of the second PET sheet was taped to the leading edge of the aluminum plate. The leading edge of the aluminum plate was placed into a hand operated laminator. The top sheet of PET and the glass fabric were peeled backwards to allow access to the sheet of DBEF. A bead of resin was applied to the edge of the DBEF closest to the laminating rolls. The sandwich construction was fed through the laminator at a steady rate forcing the resin through the glass fabric and coating the DBEF.

The laminate, still attached to the aluminum plate, was placed in a vacuum oven heated between 60° C. and 65° C. The oven was evacuated to a pressure of 27 inches (68.6 cm) of Hg and the laminate was degassed for four minutes. The vacuum was released by introducing nitrogen into the oven. The laminate was passed through the laminator once more. The resin was cured by passing the laminate beneath a Fusion “D” lamp operating at 600 W/in (240 W/cm) at a speed of 15 cm s⁻¹.

A second layer of reinforcement was provided on the opposing side of the DBEF film using the following technique. The bottom sheet of PET was carefully stripped away from the DBEF film. The top PET sheet, bearing the encapsulated glass fabric on DBEF, was placed face up on the aluminum plate and its leading edge taped down as previously described. A second sheet of glass fabric was laid on the second side of the DBEF and covered with another sheet of PET that then had its leading edge taped to the aluminum plate. The leading edge of the aluminum plate was placed into the hand operated laminator. The top sheet of PET and the glass fabric were peeled backwards to allow access to the sheet of DBEF. A bead of resin was applied to the edge of the DBEF closest to the laminating rolls. The sandwich construction was fed through the laminator at a steady rate forcing the resin up through the fiberglass fabric and coating the second side of the DBEF.

The laminate was degassed using the same technique described above for degassing the resin layer on the first side of the DBEF. The laminate was passed through the laminator once more. The resin was cured by passing the laminate beneath a Fusion “D” lamp operating at 600 W/in (240 W/cm) at a speed of 15 cm s⁻¹.

Both sheets of the PET were removed from the fiber reinforced DBEF composite. The resulting DBEF composite of Example 1 was characterized visually, through warp testing and through optical measurements.

Upon visual inspection, the qualitative transmission and polarization effectiveness of the DBEF was similar for the fiber reinforced sample when compared to DBEF-D400, a reflective polarizer available from 3M Company, St. Paul, Minn., which uses a layer of DBEF sandwiched between two polycarbonate layers.

The optical and warp properties of samples from Example 1 were tested and the results are discussed below in Tables III and VI.

### Example 2

### DBEF Directly Attached to Composite Layer

Example 2 used fiber material A for reinforcement, but with a reactive silane-based CS767 finish on the glass fiber. This is a surface finish claimed by the manufacturer to improve adhesion of the glass fibers to epoxy, polyamide and cyanate ester resins. The resin mixture, Resin Mixture 3, was formed with the following weight % of the different resin components:

| Resin Component | Wgt % |
|---|---|
| C | 69.3 |
| H | 29.7 |
| G | 1.04 |

After curing, Resin Mixture 2 had a measured refractive index of 1.5517. A layer of woven fiber fabric glass and resin were applied to, degassed, and cured onto each side of a piece of primed DBEF film, as described above for Example 1.

A summary of the optical properties of the sample made in Example 2 are included in Table III, and the mechanical properties are summarized in Tables IV and V.

### Example 3

### DRPF Directly Attached to Composite Layer

Example 3 was the same as Example 2 except that the reflective polarizer was a sheet of diffuse reflecting polarizer film, supplied by 3M Company, St. Paul, Minn., under the name DRPF. The optical properties of the Example 3 samples are summarized in Table III.

### Example 4

### APF Directly Attached to Composite Layer

Example 4 used the same glass fiber fabric and resin as in Example 3. The reflective polarizer film was a sheet of APF (Advanced Polarizer Film), a uniaxially stretched multilayer reflective polarizer available from 3M Company, St. Paul, Minn. In this film, the value of nz in the birefringent layer is matched to the value of nₓ of the birefringent layer.

The curing and attachment process used for Example 4 was the same as that used for Example 2, except for the primer being made of 97 wt % Tripropylene Glycol Diacrylate (SR 306 product code from Sartomer) and 3 wt % benzophenone. Also, the light exposure for the priming was done at 50 feet per minute (0.25 m s⁻¹).

Table III summarizes the optical characteristics of the film of Example 4, while Tables IV and V show measured mechanical characteristics, for the polarizer film both with and without the composite layer attached.

### Example 5

### DBEF laminated With Xylex Glass Fiber Composite

A reflective polarizer film described previously as DBEF was laminated to a 7 mil (175 μm) Xylex polymer glass fiber composite construction with UV curable UVX1962 acrylate adhesive. The Xylex-glass fiber composite structural layer was created by blending 10 wt % milled glass fibers from Owens Corning with Xylex 7200, a copolyester/polycarbonate blend available from General Electric Plastics using a 25 mm co-rotating twin screw extruder. The 5 mil (125 μm) Xylex-glass fiber composite layer was coextruded at 271° C. with two 1 mil (25 μm) Xylex skin layers to produce a composite structural layer thickness of 7 mils (175 μm). A layer of UVX1962 adhesive, 1 mil (25 μm) thick, was then coated onto the DBEF prior to lamination with the Xylex glass fiber composite construction. Curing of the UVX1962 acrylate adhesive was accomplished by passing the laminated construction under 2 UV D bulbs with a light intensity of 400 Watts/inch (160 W/cm) at a linespeed of 20 fpm (10 cm/s). After lamination of the DBEF reflective polarizer to the Xylex polymer glass fiber composite with UV curable adhesive, the final film construction that was 12 mils thick (300 μm). The brightness increase from this composite film measured with an effective transmission tester was 1.65.

### Example 6

### DBEF Coextrusion Coated With PMMA-Glass Fiber Composite Skins

The starting reflective polarizer film was a PEN/CoPEN multilayered stack as described in Example 5. The reflective polarizer film was preheated to a temperature of 65° C. using an infra-red heater, and then fed into a nip at 7.5 fpm (3.8 cm s⁻¹) while simultaneously being coextrusion coated with a PMMA top coat layer, a PMMA-glass fiber reinforced structural layer and a CoPEN5050HH tie-layer.

The PMMA-glass fiber composite polymer contained 20 wt. % glass fibers and was supplied by Polyone Corp, Avon Lake, Ohio, under the trade name PMMA-20FG. The PMMA top-coat layer, the PMMA-glass composite layer and the CoPEN5050HH tie-layer were coextruded at 271° C. onto the multi-layer reflective polarizer to produce a PMMA top coat layer thickness of 1.0 mil (25 micron), a PMMA fiber glass composite structural layer thickness of 4 mils (100 μm) and a tie-layer thickness of 1 mil (25 μm). The multi-layer polarizer, with the extrusion coated layers, was pressed against a casting wheel at 83° C. having an rms surface roughness of 150 nm rms with a rubber nip roll to provide a matte finish on the top skin coat. The combined multi-layer reflective polarizer and coextrusion coated PMMA fiber glass composite formed a final film construction that was 10 mils (250 μm) thick. The brightness increase from this composite film measured with an effective transmission tester was 1.67.

### Example 7

### DBEF With SAN-Glass Fiber Composite Skins

A reflective polarizer film, previously described as DBEF, was preheated to a temperature of 65° C. using an infra-red heater, and then fed into a nip at 7.5 fpm (3.7 cm/s) while simultaneously being coextrusion coated with a SAN glass fiber polymer composite structural layer and a CoPEN5545HD tie layer. The SAN-glass fiber composite structural layer was created by blending 10 wt % milled glass fibers from Owens Corning with SAN Tyril 880 (styrene acrylonitrile available from Dow (Midland Michigan). The combined 3 mil (75 μm) thick SAN-glass fiber composite layer, 0.5 mil (13 μm) thick CoPEN5545HD tie layer, and 4 mil (100 μm) thick multi-layer reflective polarizer had a total thickness of 7.5 mil (188 μm). The multi-layer polarizer, with the coextrusion coated layers, was pressed with a nip roll against a casting wheel at 83° C. having an rms surface roughness of 150 nm to provide a matte finish on the SAN surface. The same process was repeated to apply another CoPEN5545HD tie-layer and another composite structural layer on the opposite side of the multi-layer reflective polarizer to create final film construction that was 11 mils thick.

### Example 8

### DBEF Laminated With NAS30 Woven Fiberglass Polymer Composite

A glass fiber reinforced polymer composite may be made by extrusion coating a refractive index matched polymer such as a styrene-acrylate copolymer (NAS30 available from Nova Chemicals (Moon Township, Pa.)) into woven fiber glass cloth made by Hexcel Reinforcements Corp and then subsequently laminated to DBEF with UV curable adhesive. For example, NAS30 may be extruded at 270° C. and simultaneously fed with woven fiber glass cloth into a high pressure nip and quenched against a casting wheel as shown in FIG. 3B, producing a woven fiber glass polymer composite having a thickness of approximately 5 mils (125 μm). The casting wheel surface may be textured, for example with an rms surface roughness of 150 nm, to provide a matte finish to the woven glass fiber polymer composite.

Previously made DBEF may then be coated with a layer approximately 1 mil (25 μm) thick of UVX1962 adhesive and then laminated to the styrene-acrylate woven glass fiber composite construction. Curing of the UVX1962 acrylate adhesive may then be accomplished by passing the laminated construction under a source that provides a suitable amount of UV radiation, for example as is described in Example 5. After lamination of the reflective polarizer to the styrene-acrylate copolymer woven glass fiber composite with UV curable adhesive, the final film construction is around 10 mils thick (250 μm).

### Example 9

### DBEF Coextrusion Coated With Xylex and Woven Glass Fiber Cloth

A multi-layer reflective polarizer such as DBEF may be coextrusion coated with a refractive index matching polymer such as Xylex 7200 and a woven glass fiber cloth such as made by Hexcel Reinforcements Corp. For example, Xylex 7200 may be extruded at 270° C. and simultaneously fed with woven fiber glass cloth and DBEF into a high pressure nip and quenched against a casting wheel as shown in FIG. 3B, producing a woven fiber glass polymer composite having a thickness of 8 mils (200 μm). The DBEF and woven fiber glass cloth may be preheated to a temperature of 85° C. using an infra-red heater. The casting wheel surface may be textured, for example with an rms surface roughness of approximately 150 nm, to provide a matte finish to the woven glass fiber polymer composite.

### Example 10

### DBEF Coextrusion Coated With Xylex and Woven Glass Fiber Cloth

A multi-layer reflective polarizer such as DBEF may be coextrusion coated with a refractive index matching polymer such as Xylex 7200 and a woven glass fiber cloth such as made by Hexcel Reinforcements Corp. For example, Xylex 7200 may be extruded at 270 aC and simultaneously fed with woven fiber glass cloth and DBEF into a high pressure nip and quenched against a casting wheel as shown in FIG. 3B, producing a woven fiber glass polymer composite having a thickness of 8 mils (200 μm). The DBEF and woven fiber glass cloth may be preheated to a temperature of 85° C. using an infra-red heater. The casting wheel surface may be textured, for example with an surface roughness of around 150 nm rms, to provide a matte finish to the woven glass. fiber polymer composite. The same polymer fiber glass cloth coextrusion coating process may then be repeated on the opposite side of the DBEF layer to produce a polymer glass fiber composite having a total thickness of about 12 mils (300 μm).

### Example 11

### Comparative Example, DBEF With Coextrusion Coated PMMA Layer

In this example, a multi-layer reflective polarizer previously described as DBEF was coextrusion coated with PMMA and a COPEN adhesive tie-layer. The reflective polarizer was preheated to a temperature of 65° C. with an infra-red heater and fed into a nip roller at a speed of 7.5 fpm (3.8 cm s⁻¹) while simultaneously being coextrusion coated with a PMMA top skin coat layer, a PMMA structural layer, and a CoPEN5050HH tie-layer. The PMMA used as the structural layer and topcoat layer was supplied by Atofina under the tradename VO44. The PMMA top coat layer, the PMMA structural layer, and the CoPEN5050HH tie-layer were coextruded at 271° C. onto the multi-layer reflective polarizer to produce a top coat PMMA layer thickness of 1 mil (25 microns), a PMMA structural layer thickness of 4 mils (100 μm) and a tie-layer thickness of 1.0 mils (25μ). The extrusion coated layers were pressed against a casting wheel at 83° C. having an rms surface roughness of 150 nm, with a rubber nip roll to provide a matte finish on the top skin coat. The combined multi-layer reflective polarizer and coextrusion coated layers had a total thickness of 10 mils (250 μm).

The PMMA coextrusion coated polarizer film was exposed to a warp test, described below and was observed to suffer from an unacceptable level of warp.

Optical Properties

The different example composites were tested for optical transmission, reflection, haze and color. Transmission (T), haze (H) and clarity (C) measurements were made using a BYK Gardner Haze-Gard Plus instrument, catalog no. 4723 and supplied by BYK Gardner, Silver Spring, Md. The transmission and haze levels can be defined according to ASTM-D1003-00, titled “Standard Test Method for Haze and Luminous Transmittance for Transparent Plastics”. The instrument was referenced against air during the measurements. Light transmission (T) measurements are provided as a percentage of transmission. Haze is the scattering of light by a specimen responsible for the reduction in contrast of objects viewed through it. Haze, H, is presented as the percentage of transmitted light that is scattered so that its direction deviates more than a specified angle from the direction of the incident beam. Clarity is evaluated using a ring detector and comparing the small-angle scattered light component to the specularly transmitted component. The exact angular ranges of scattering and the resulting data are defined by the construction of the instrument used for these measurements.

The color in 1976 CIE L* a* b* color space was measured using a BYK Gardner Colorsphere (Cat. No. 6465,). The testing procedure was similar to that described in ASTM E1164: Obtaining Spectrometric Data for Object-Color Evaluation. The instrument was calibrated to calculate the color shift of the sample from air.

Light transmission (% T) and reflection (% R) measurements were made using a Perkin-Elmer Lambda 900 Spectrophotometer (Model: BV900ND0) fitted with a PELA-1000 integrating sphere accessory over the 400-700 nm range. This sphere is 150 mm (6 inches) in diameter and complies with ASTM methods E903, D1003, E308, et al. as published in “ASTM Standards on Color and Appearance Measurement”, Third Edition, ASTM, 1991. The instrument was referenced against air during the measurement. The scan speed of the spectrophotometer was ˜1250 nm/minute with a UV-Visible integration of 120 ms/pt. The data interval and resolution were 5 nm. Transmission and reflection data are presented as percentages as measured at 550 nm. The reflection data were calibrated against a known specular reflectance standard.

The thickness of each sample was measured at four different points. The data under the column marked (t) shows the average of the thickness measurement, in microns.

Relative gain, which may also be referred to as effective transmission, was measured by placing sample films on a diffusely transmissive hollow light box illuminated using a stabilized broadband source. The axial luminance (normal to the plane of the film) was measured through an absorbing polarizer using a SpectraScan™ PR-650 SpectraColorimeter available from Photo Research, Inc, Chatsworth, CA. Relative gain was calculated by applying a spectral weighting to the luminance measurement and dividing the measured luminance with the sample film in place by the measured luminance without the sample film in place (light box only). This measurement provided stable and reproducible comparative gain values between different film samples.

The % reflectance values marked with an asterisk indicate that the measurement was obtained from the sample when the pass axis of the polarizer was in the vertical position only. All other % reflectance values are calculated as the average of the % reflectance measured with the polarizer pass axis vertical, and the polarizer pass axis horizontal. Further, for all the non-asterisked reflection and transmission measurements, a beam depolarizer was used in the Lambda 900 to create depolarized light for the measurements. Because the depolarization is not complete, the average of the transmission and reflection measurements in the two alignment states are reported for all the samples except those marked with a “*”.

The thickness of the composite films attached to the polarizer was ˜41 microns for the DBEF samples (Examples 1 and 2), ˜39 microns for the DRPF sample (Example 3), and about 46 microns for the APF sample (Example 4).

The gain measurements demonstrate that there is generally a very small decrease in gain when the base polarizer film is combined with the composite. The loss in gain is likely due to light scattering from contaminants, incomplete index matching of the resin to the H-106 fiberglass, or bubbles that were incompletely displaced by the resin system, and remain in the composite.

The transmission and reflection values measured on the Lambda 900 are very comparable between the “naked” polarizer films and the polarizer films with a layer of composite on each side.

Slight differences in the L*, a* and b* measurements are noted between the polarizer film and the corresponding composites. In the case of DRPF and APF, the composites contribute to slight increases in b* value. However, in the case of DBEF, the b* values of the DBEF composite are slightly less than the corresponding DBEF film.

The results for T, H, and C measured on the BYK Haze-Gard are mixed. In some cases, the composites show decreased clarity and increased haze; in other cases, the composites show increased clarity and decreased haze (in comparison to the parent optical films). The results are summarized in Table III, along with control examples that correspond to Examples 2-4 but which had no fiber reinforcement: these control examples are identified in the table with “none” in the column for glass material.

TABLE III
Optical Properties of Examples 1-5 and two control samples

| | | | | | | | | | | Avg. | | | |
|---|---|---|---|---|---|---|---|---|---|---|---|---|---|
| Example | Polarizing | Glass | Pass axis | | | | | | | Thickness | | % T @ | % R @ |
| No. | Film | Material | Orientation | T | H | C | L* | a* | b* | (mm) | Gain | 550 nm | 550 nm |
| 1 | DBEF | H-106 | | 51.5 | 9.9 | 94.6 | 75.17 | 1.54 | 2.25 | — | 1.659 | 21.6/77.2 | 75.1/21.7 |
| 2 | DBEF | none | vert | 55.4 | 0.9 | 99.6 | 74.07 | 2.17 | 2.42 | 0.096 | 1.679 | 46.8 | 51.9 |
| 2 | DBEF | none | horiz | 50.8 | 0.8 | 99.6 | 75.27 | 2.33 | 2.63 | | | | |
| 2 | DBEF | H-106 | vert | 56.9 | 3.0 | 94.3 | 74.13 | 1.56 | 2.05 | 0.179 | 1.675 | 46.7 | 51.6 |
| 2 | DBEF | H-106 | horiz | 51.3 | 3.2 | 94.2 | 75.4 | 1.83 | 2.36 | | | | |
| 3 | DRPF | none | vert | 60.1 | 30.9 | 89.8 | 75.48 | 0.26 | 2.95 | 0.127 | 1.554 | 49.8 | 46.5* |
| 3 | DRPF | none | horiz | 55.7 | 34.5 | 90.4 | 76.44 | 0.55 | 3.34 | | | | |
| 3 | DRPF | H-106 | vert | 60.3 | 26.1 | 93.6 | 75.36 | 0.09 | 3.29 | 0.205 | 1.544 | 49.9 | 44.6 |
| 3 | DRPF | H-106 | horiz | 55.6 | 28.7 | 93.6 | 76.58 | 0.4 | 3.62 | | | | |
| 4 | APF | none | vert | 55.4 | 0.77 | 99.9 | 73.34 | −0.33 | 0.55 | 0.036 | 1.704 | 46.75 | 52.51 |
| 4 | APF | none | horiz | 49.7 | 0.58 | 99.7 | 74.62 | 0.11 | 0.78 | | | | |
| 4 | APF | H.106 | vert | 55.2 | 3.29 | 97.9 | 73.22 | −0.54 | 0.85 | 0.128 | 1.696 | 46.33 | 52.65 |
| 4 | APF | H.106 | horiz | 49.4 | 3.48 | 98 | 74.5 | −0.11 | 1.18 | | | | |

Mechanical Properties

The coefficient of thermal expansion (CTE) for Examples 2 and 4 was measured using standard thermal-mechanical analysis on a Perkin Elmer TMA 7 with film tension geometry. Terminology relating to standard TMA testing is defined according to ASTM E-473 and ASTM E-11359-1. The CTE test was performed by first heating the samples gradually to 110° C. (‘first heat’) to eliminate residual stresses, cooling the samples and allowing them to relax, and finally heating the samples again from 20° C. to 110° C. (2^{nd} heat CTE). For most samples the CTE was calculated by using a linear expansion region from 30-110° C., though for a few samples this calculation range was reduced to 30-100° C. or 30-80° C. due to non-linear behavior in the high-temperature region. The measurements were made for the CTE in two directions, namely parallel to the pass axis of the polarizer and parallel to the block axis of the polarizer.

The measurements of CTE are summarized in Table IV. The table lists the sample number or shows whether the sample was a control measurement. Control measurements were made on DBEF and APF films that were not attached to reinforced composite layers. The table also lists a brief description of the sample, and provides the average 2^{nd} heat CTE in ppm per ° C. The CTE measurements were made independently in two different directions, parallel to the pass axis of the polarizer and parallel to the block axis of the polarizer.

TABLE IV
Coefficient of thermal expansion (CTE) values measured for some
representative samples illustrating the utility of the invention.

| | | | | Control-Composite |
|---|---|---|---|---|
| Example | | Polarizer | Avg. 2nd heat | Reduction in |
| # | Brief Description | orientation | CTE (ppm/° C.) | CTE (ppm/° C.) |
| | DBEF with H-106 | | | |
| 2 | composite | pass | 45.6 | 46.8 |
| Control | DBEF control | pass | 92.4 | |
| | DBEF with H-106 | | | |
| 2 | composite | block | 36.4 | 0.7 |
| Control | DBEF control | block | 37.1 | |
| 4 | APF Composite with H-106 | pass | 34.2 | 73.8 |
| Control | APF Control | pass | 107.9 | |
| 4 | APF Composite with H-106 | block | 36.2 | −8.3 |
| Control | APF Control | block | 28.0 | |

It is worth noting that the majority of the CTE reduction for these composite polarizer samples (compared to the controls) occurs in the pass-axis (non-stretched) direction, while the CTE's in the block direction do not change appreciably and can be considered to vary by an amount that is similar to the measurement error. This may be due to the higher crystallinity in the stretch direction as well as some slow residual shrinkage that occurs in that direction. The pass axis direction is of primary concern for CTE-induced warping in displays. The CTE in the pass axis is typically higher than in the block axis. This is can be seen by comparing the values of CTE for the control examples in the pass and block directions. In the DBEF control example, the CTE in the pass axis direction is 92.4 ppm/° C., whereas it is 37.05 ppm/° C. in the block direction, a ratio of nearly 2.5. In the APF control example, this ratio is almost 3.9. This differential in the thermal expansion of a polarizer can lead to severe warping when the polarizer is raised in temperature, and so the reduction of CTE in the pass axis direction is of significant importance, even if the CTE remains the same in the block direction. In comparison, the use of a composite layer with the reflective polarizer significantly reduces the ratio (around 1.26 for the DBEF example and around 0.94 in the APF example). In both examples, the ratio of the pass axis CTE to the block axis CTE is less than 1.5. By suppressing the pass axis CTE using the composite layer, the pass axis CTE has become nearly equivalent to the block axis CTE. This near equivalence of the CTEs is desirable because it increases the isotropy of the material in product applications where the composite layer is subjected to thermal stresses.

The storage modulus and stiffness (in tension) were measured with Dynamic Mechanical Analysis (DMA) using a TA instruments model no. Q800 DMA with film tension geometry. Terminology relating to DMA testing can be defined according to ASTM D-4065 and ASTM D-4092. Reported values are at room temperature (24° C.). The stiffness results are summarized in Table V. The measurements were made at a temperature in the range 24° C. -28° C. The table shows the marked increase in storage modulus which can be obtained using the composite materials, in particular the composites containing continuous woven reinforcements. These high values of tensile modulus and stiffness can be considered to correspond to potential bending stiffness as well, depending on final article construction and geometry: proper placement of the high-modulus layers results in an article having high bending stiffness. Final article stiffness also depends on the properties of the other layers, for example a rigid curable laminating adhesive will typically be preferable to a pressure-sensitive adhesive to enhance stiffness in those articles requiring an adhesive.

As in Table IV, Table V lists the sample number along with a brief description of the sample. The table also lists the orientation of the measurements relative to the pass or block axes of the polarizer, and lists the average storage modulus and the average stiffness. The last column shows the increase in the storage modulus between the reinforced polarizer and the unreinforced polarizer. The table shows results for Examples 2, 4, 5 and 6, along with various DBEF and APF control samples that were measured without any attached reinforced composite layer.

As was discussed above for CTE, it may be desirable in some embodiments to have similar modulus values in various sample orientations, for example, the pass and block axes of a polarizer. This can lead to increased material isotropy and may reduce the impact of differential material responses when subjected to thermal stresses. The ratio, Rₘ, is defined as the ratio of the modulus in the block direction to the modulus in the pass direction. For the DBEF control sample, the value of Rₘ is approximately 1.6 and for the APF control, the value of Rₘ is approximately 2.4. With the addition of the composite layers, the values of Rm are reduced to 0.9 for the DBEF composite and 1.1 for the APF composite. For the DBEF coextruded samples, the values of Rₘ were 1.1 and 0.8 for Examples 5 and 6, respectively. In all of these examples, the ratio of the modulus in the composite-reinforced polarizers is less than 1.3. In all of these cases, the application of the composite to the polarizer increased the isotropy of the modulus of the polarizer construction. In some cases, it may be desirable to have a pseudo-balanced product construction with near isotropy in both the CTE and the modulus properties.

TABLE V
Storage Modulus and Stiffness measured in tension mode.

| | | | | Ratio of | | Average |
|---|---|---|---|---|---|---|
| Example | | Polarizer | Average Storage | Composite Modulus | | Stiffness |
| # | Brief Description | orient. | (MPa) | to Control Modulus | Rₘ | (kN/m) |
| | DBEF with H-106 | | | | | |
| 2 | composite | pass | 7895 | 2.67 | 0.9 | 400 |
| Control | DBEF control | pass | 2954 | | 1.6 | 84.4 |
| | DBEF with H-106 | | | | | |
| 2 | composite | block | 7103 | 1.51 | | 378.5 |
| Control | DBEF control | block | 4713 | | | 131.8 |
| | APF Composite with | | | | | |
| 4 | H-106 | pass | 9341 | 3.88 | 1.1 | 356.9 |
| Control | APF Control | pass | 2408 | | 2.4 | 26.0 |
| | APF Composite with | | | | | |
| 4 | H-106 | block | 10510 | 1.82 | | 404.9 |
| Control | APF Control | block | 5753 | | | 63.0 |
| 5 | DBEF-Lamn | pass | 2500 | — | 1.1 | 305.6 |
| 5 | DBEF-Lamn | block | 2685 | | | 326.0 |
| 6 | DBEF-Coext | pass | 3984 | — | 0.8 | 352.8 |
| 6 | DBEF-Coext | block | 3249 | | | 310.9 |

Different samples were tested for warp. The method selected was to expose the samples to conditions where the temperature was cycled and then to manually examine the resulting film. The control sample had very noticeable rippling and shadows after warp testing, termed high warp visibility. The example film was deemed to have low warp visibility if the discernable shadows in the film were much less visible or non-existent when compared to the control sample.

The method used for temperature cycling was as follows: Clean two 9.5″×12.5″(24.1×31.8 cm) flat pieces of double strength glass were cleaned with isopropyl alcohol. A 9″×12″(22.9×30.5 cm) piece of the film being tested was attached to one piece of glass on two short sides and one of the long sides, leaving the remaining long side unconstrained. The film was attached by applying Double Stick Tape (available from 3M Company, St. Paul, Minn.) to a piece of glass such that the tape was 0.5″(1.3 cm) from three edges of the glass and was exactly covered by three sides of the film. The ends of the tape were not overlapped. The film was placed on the tape such that the film was tensioned across the tape and was held above the glass surface by the thickness of the tape (about 0.1 mm). A 4.5 lb. (2 kg) roller was rolled once in each direction over the film and tape, avoiding extra force, to adhere the film to the tape.

Three 0.1 mm thick, 0.5″ (1.3 cm) wide, polyethylene terephthalate (PET) shims were placed onto the rolled film, the shims being exactly above the tape and of the same lengths as the tape, but on the opposite side of the film. The films were not overlapped. The top piece of glass was placed top of the shims and exactly aligned with the bottom piece of glass.

This glass/film/glass sandwiched construction contains the film constrained at three edges and substantially free floating in the center. The sandwich construction is attached together with four binder clips. The clips were selected to be of an appropriate size so as to apply pressure to the center of the tape (approximately 0.75″ (1.9 cm) from the edge of the glass) and were positioned two each on the short sides of the construction, each about 0.75″ (1.9 cm) away from the bottom and top of the film.

The completed construction was placed in a thermal shock chamber (Model SV4-2-2-15 Environmental Test Chamber, Envirotronics, Inc., Grand Rapids, Mich.) and subjected to 96 cycles, a cycle comprising one hour at 85° C. followed by one hour at −35° C. The film was then removed from the chamber and inspected for wrinkles. The example film was deemed to have low warp visibility if the discemable shadows in the film were much less visible or non-existent when compared to the control sample.

Table VI, below, shows the warp test results for various samples compared against a control film of DBEF (Example 11) tested without fiber reinforcement.

TABLE VI
Warp test results

| Example No. | Warp visibility |
|---|---|
| 1 | low |
| 5 | low |
| 6 | low |
| 7 | low |
| 11 | high |

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An optical film, comprising:
a first layer and a second layer, the first and second layers each comprising fibers embedded within respective polymeric matrices; and
a third layer comprising a reflective polarizer layer, the third layer being mounted between the first and second layers.

2. An optical film as recited in claim 1, wherein the third layer is adhesively attached between the first and second layers.

3. An optical film as recited in claim 1, wherein the third layer is directly attached to the first and second layers.

4. An optical film as recited in claim 3, wherein the third layer is directly attached to the first and second layers using a primer.

5. An optical film as recited in claim 1, wherein the optical film has a first coefficient of thermal expansion (CTE) related to a first direction across the film and a second CTE related to a second direction across the film orthogonal to the first direction, and a ratio of the first CTE to the second CTE is no greater than 1.5.

6. An optical film as recited in claim 1, wherein the optical film has a first modulus related to a first direction across the film and a second modulus related to a second direction across the film orthogonal to the first direction, and a ratio of the first modulus to the second modulus is no greater than 1.3.

7. An optical film as recited in claim 1, wherein the optical film has a first coefficient of thermal expansion (CTE) related to a first direction across the film and a second CTE related to a second direction across the film orthogonal to the first direction, and a ratio of the first CTE to the second CTE is no greater than 1.5, and the optical film has a first modulus related to the first direction and a second modulus related to the second direction, and a ratio of the first modulus to the second modulus is no greater than 1.3.

8. An optical film as recited in claim 1, wherein at least one of the polymer matrices of the first and second layers comprises a thermosetting polymer matrix.

9. An optical film as recited in claim 8, wherein at least one of the first and second layers comprises a thermoplastic polymer matrix.

10. An optical film as recited in claim 8, wherein, in at least one of the first and second layers, the refractive index of the inorganic fibers is substantially matched to the refractive index of the respective polymer matrix.

11. An optical film as recited in claim 1, wherein the reflective polarizing layer comprises a multilayer stack of alternating materials.

12. An optical film as recited in claim 1, wherein the reflective polarizing layer comprises a diffuse reflecting polarizer.

13. An optical film as recited in claim 1, wherein at least some of the fibers in one of the first and second layers have a refractive index substantially matched to a refractive index of the respective polymeric matrix.

14. An optical film as recited in claim 1, wherein at least some of the fibers in one of the first and second layers have a refractive index that is not substantially matched to a refractive index of the respective polymeric matrix.

15. A method of manufacturing an optical film, comprising:
providing a reflective polarizer layer; and
attaching a first fiber reinforced layer to a first side of the reflective polarizer layer, the first fiber layer comprising inorganic fibers disposed within a first polymer matrix.

16. A method as recited in claim 15, wherein attaching the first fiber reinforced layer comprises disposing an adhesive layer on at least one of the reflective polarizer layer and the first fiber reinforced layer, and pressing the reflective polarizer layer and the first fiber reinforced layer together.

17. A method as recited in claim 16, further comprising curing the adhesive layer.

18. A method as recited in claim 15, further comprising disposing a primer layer on at least one of the reflective polarizer layer and the first fiber reinforced layer before attaching the first fiber reinforced layer to the first side of the reflective polarizer layer.

19. A method as recited in claim 15, wherein attaching the fiber reinforced layer comprises contacting the first fiber reinforced layer to the reflective polarizer layer and then curing the first fiber reinforced layer while in contact with the fiber reinforced layer.

20. A method as recited in claim 15, wherein attaching the fiber-reinforced layer comprises extruding the first fiber-reinforced layer onto the reflective polarizer layer and then curing the first fiber-reinforced layer.

21. A method as recited in claim 20, further comprising extruding a strippable layer on the first fiber-reinforced layer.

22. A method as recited in claim 21, wherein extruding the strippable layer comprises co-extruding the strippable layer with the first fiber-reinforced layer.

23. A method as recited in claim 15, further comprising attaching a second fiber reinforced layer to a second side of the reflective polarizer layer.

24. A method as recited in claim 23, wherein the second fiber reinforced layer comprises in organic fibers disposed within a second polymer matrix.
